(19) United States
(12) Patent Application Publication
(10) Pub. No.: US 2013/0246083 A1
(43) Pub. Date: Sep. 19, 2013

(54) METHODS OF DISTRIBUTING COMPLEMENT-INHIBITING DRUGS TO PATIENTS RECEIVING A COMPLEMENT INHIBITOR

(71) Applicant: Leonard Bell, Woodbridge, CT (US)

(72) Inventor: Leonard Bell, Woodbridge, CT (US)

(73) Assignee: Alexion Pharmaceuticals, Inc., Cheshire, CT (US)

(21) Appl. No.: 13/621,654

(22) Filed: Sep. 17, 2012

Related U.S. Application Data
(60) Provisional application No. 61/611,870, filed on Mar. 16, 2012.

(51) Int. Cl. G06F 19/00

(52) U.S. Cl. CPC G06F 19/322
USPC 705/2

(57) ABSTRACT

This disclosure relates to methods of authorizing distribution of complement-inhibiting drugs to patients who have a complement-associated disorder in a manner to ensure that the patients are aware of the possible dangers of discontinuing treatment with the drugs. A database is prepared comprising patient information including experiencing adverse clinical events after discontinuing the drug treatment. The information in the database is collected and may be reported. The patients are given a warning as to adverse events that may occur if treatment with the complement inhibiting drugs is discontinued.

### RELATED APPLICATIONS

This application claims the benefit of priority to U.S. Provisional Application No. 61/611,870, filed on Mar. 16, 2012. The specification of the foregoing application is incorporated herein by reference in its entirety.

### BACKGROUND

Complement is an essential component of the immune system and is of substantial relevance for the destruction of invading microorganisms and for maintaining tissue homeostasis including the protection against autoimmune diseases. However, excessive or uncontrolled complement activation significantly contributes to undesired tissue damage. Complement activation presents a considerable risk of harming the host by directly and indirectly mediating inflammatory tissue destruction. Clinical and experimental evidence underlines the prominent role of complement in the pathogenesis of numerous inflammatory diseases.

In recent years, great progress has been made in inhibiting complement activation for potential therapies for complement-relevant diseases. A certain degree of inhibition of complement activation may be sufficient to reduce its detrimental effects but still preserve the defense mechanisms against invading pathogens. The redundancy of the three complement activation pathways may reduce the risk of infection if only one pathway is selectively blocked. In addition, the risk of infectious complications is most probably highest when blocking the comparatively upstream complement component C3. Some complement inhibitors, including antibodies or antigen-binding fragments specifically recognizing and antagonizing the downstream complement component C5, e.g., eculizumab (Soliris®) and pexelizumab, have been prepared and/or tested in clinical trials. Due to their inhibition of C5 cleavage and terminal C5b-9 complex formation, these inhibitors could lead to increased susceptibility to certain pathogens, such as Neisseriae. However, due to the fact that very few of these complement inhibitors have been approved by FDA for marketing or even clinical trials, more information about these inhibitors are needed for any representative adverse effects, especially for any possible adverse effects after long-term use or discontinuing use of these complement inhibitors.

### BRIEF SUMMARY OF THE DISCLOSURE

The present disclosure generally relates to an unexpected discovery of adverse clinical events, including severe adverse effects, after discontinuing use of a certain drug, such as a complement inhibitor (i.e., eculizumab (Soliris®)) used to treat paroxysmal nocturnal hemoglobinuria (PNH) or atypical hemolytic uremic syndrome (aHUS) patients. In one aspect, the disclosure provides a method for distributing a drug to a patient in need by authorizing distribution of the drug on the condition that the patient or a representative of the patient acknowledges the risk of side effects of the drug, discontinuance of the drug, or both. After acknowledgment of a receipt of a warning regarding such risks, the acknowledgment is registered in a database, for example along with an identification of such risks and side effects, to help evaluate later patient compliance and clinical successes and failures. In certain example implementations, the disclosure provides a method for distributing a complement inhibitor (CI1) for use in treating a patient: (i) afflicted with, suspected of having, or at risk for developing a complement-associated disorder, and (ii) in need of treatment with the complement inhibitor, the method comprising:

i) authorizing distribution of a complement inhibitor to treat the patient, upon certification that:
(a) the patient, or the legal guardian or representative of the patient, is competent to comprehend and assess information and to make decisions;
(b) the patient, or the legal guardian or representative of the patient, has received one or both of verbal and written warning as to the risk of adverse clinical events associated with discontinuing use of a complement inhibitor to treat said disorder; and
(c) the patient, or the legal guardian or representative of the patient, has expressed acknowledgment of the warning and agreement to the treatment;

ii) registering via a computer readable medium a database comprising the information that the patient, or the legal guardian or representative of the patient, has received and acknowledged the warning and agreed to the treatment; and

iii) following (i) and (ii), distributing the complement inhibitor for use in treating the patient.

In another aspect, the present disclosure provides a method of promoting a patient's compliance to a medical treatment for a complement-associated disorder with a complement inhibitor (CI1), comprising:

i) advising the patient, or the legal guardian or representative of the patient, via one or both of verbal and written warning as to the risk of adverse clinical events associated with discontinuing use of the complement inhibitor to treat said disorder;

ii) obtaining acknowledgement of the warning and agreement to the treatment from the patient, or the legal guardian or representative of the patient;

iii) registering via a computer readable medium a database comprising patient information, wherein the patient information includes that the patient, or the legal guardian or representative of the patient, has been provided with the warning, has acknowledged the warning, and has agreed to the treatment; and

iv) authorizing distribution of the complement inhibitor for treating the patient.

In some embodiments, the complement-associated disorder is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD). In some embodiments, the patient is monitored for adverse clinical events after discontinuing use of the complement inhibitor (CI1). In one embodiment, the patient is treated by re-initiation of the complement inhibitor (CI1) treatment or with an alternative therapy to treat the adverse clinical events after discontinuing use of the complement inhibitor (CI1). In another embodiment, the alternative therapy comprises treating with a different complement inhibitor (CI2) or with a different regimen of the same complement inhibitor (CI1). In still another embodiment, the alternative therapy comprises plasma therapy, or organ-specific supportive measures, or any combination thereof. In one embodiment, the plasma therapy is selected from the group consisting of: plasmapheresis, plasma exchange, and fresh frozen plasma infusion.

In some embodiments, the complement inhibitor (CI1) is an inhibitor of complement protein C5. In one embodiment, the complement inhibitor (CI1) is an antibody or antigen-binding fragment thereof recognizing C5. In one preferred embodiment, the antibody or antigen-binding fragment thereof is eculizumab (Soliris®), pexelizumab, or a biosimilar equivalent of eculizumab or pexelizumab. In one embodiment, the adverse clinical events associated with discontinuation comprise thrombotic microangiopathy (TMA) or a TMA-related complication. In one preferred embodiment, the TMA-related complication is selected from the group consisting of: changes in mental status, seizures, angina, dyspnea, and thrombosis. In another preferred embodiment, the TMA-related complication can be identified by comparing two or more measurements of a laboratory parameter selected from the group consisting of: platelet count, serum creatinine level, and serum LDH level. In one embodiment, a TMA-related complication is indicated by

i) a 25% or greater decrease in platelet count compared to baseline or the peak platelet count during treatment;

ii) an increase of 25% or greater in serum creatinine level compared to baseline or nadir level during treatment; or

iii) an increase of 25% or greater in serum LDH level compared to baseline or nadir level during treatment.

In another aspect, the present disclosure provides a method of creating a database of patients who have a complement-associated disorder, wherein said method comprises registering via a computer readable medium a database containing information of the patients, wherein the information includes that the patients, or the patients' legal guardians or representatives, have received one or both of verbal and written warning as to the risk of adverse clinical events associated with discontinuing use of a complement inhibitor to treat the disorder. In some embodiments, the complement-associated disorder is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD).

In some embodiments, the information further comprises that the patients, or the patients' legal guardians or representatives, have acknowledged the warning and agreement to the complement inhibitor treatment. In one preferred embodiment, the patients receive the warning prior to the distribution of the complement inhibitor.

In some embodiments, the complement inhibitor disclosed herein is an inhibitor of complement protein C5. In one embodiment, the complement inhibitor is an antibody or antigen-binding fragment thereof recognizing C5. In one preferred embodiment, the antibody or antigen-binding fragment thereof is eculizumab (Soliris®), pexelizumab, or a biosimilar equivalent of eculizumab or pexelizumab.

In another aspect, the present disclosure also provides a database of patients created by the methods described herein.

In another aspect, the present disclosure provides a method for reporting at least one adverse event to a government regulatory agency, the method comprising searching the database disclosed herein to determine information about patients having a complement-associated disorder and experiencing at least one adverse clinical event upon discontinuation of a therapy with a complement inhibitor (CI1) and communicating the information to a government regulatory agency.

In another aspect, the present disclosure provides a method for distributing a complement inhibitor (CI1) for treating a complement-associated disorder, wherein at least one adverse clinical event may occur upon discontinuation of the treatment with the complement inhibitor, the method comprising:

i) obtaining an approval from a government regulatory agency for distributing the complement inhibitor, wherein the government regulatory agency has been previously notified of the at least one potential adverse clinical event; and

ii) providing the complement inhibitor together with a document providing a warning comprising the information of the at least one potential adverse clinical event to a distributor, a prescriber, an authorized dispenser, or a patient having the disorder, or the legal guardian or representative of the patient.

In another aspect, the present disclosure provides a method for treating a patient with a complement inhibitor, wherein the patient is: (i) afflicted with, suspected of having, or at risk for developing a complement-associated disorder, and (ii) in need of treatment with the complement inhibitor, the method comprising:

(a) providing to the patient, or legal guardian or representative of the patient, one or both of verbal and written warning as to the risk of adverse clinical events associated with discontinuing use of a complement inhibitor (CI1) to treat the disorder;

(b) registering via a computer readable medium the information that the patient, or legal guardian or representative of the patient, has received and expressly acknowledged the warning; and

(c) following (a) and (b), administering the complement inhibitor to the patient in an amount and with a frequency effective to treat the disorder.

In another aspect, the present disclosure provides a method for treating a patient who has a complement-associated disorder and has discontinued therapy with a complement inhibitor (CI1), the method comprising:

(a) following discontinuation of complement inhibitor therapy, monitoring the patient for the presence of at least one adverse clinical event associated with discontinuation; and

(b) upon presentation of the adverse clinical event, (i) administering a therapeutically effective amount of the complement inhibitor (CI1) to the patient; (ii) administering to the patient a therapeutically effective amount of a different complement inhibitor (CI2); (iii) administering a plasma therapy to the patient; (iv) administering an organ-specific supportive measure; or (v) any combination of the foregoing.

In another aspect, the present disclosure provides a method of warning a patient who has a complement-associated disorder and is prescribed a complement inhibitor (CI1) of the risk of an adverse clinical event if the patient discontinues treatment with said complement inhibitor, the method comprising placing a written warning on the package label or package insert of said complement inhibitor.

In some embodiments, the complement-associated disorder disclosed herein is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD). In some embodiments, the patient is monitored for the adverse clinical events after the discontinuing use of the complement inhibitor (CI1).

In some embodiments, the patient is treated by re-initiation of the complement inhibitor (CI1) treatment or with an alternative therapy for the adverse clinical events after the discontinuing use of the complement inhibitor (CI1). In one embodiment, the alternative therapy comprises treating with a different complement inhibitor (CI2) or with a different regimen of the same complement inhibitor (CI1). In one preferred embodiment, the alternative therapy comprises plasma therapy, or organ-specific supportive measures, or any combination thereof. In one further preferred embodiment, the plasma therapy is selected from the group consisting of: plasmapheresis, plasma exchange, and fresh frozen plasma infusion.

In some embodiments, the complement inhibitor (CI1) of the present disclosure is an inhibitor of complement protein C5. In one embodiment, the complement inhibitor (CI1) is an antibody or antigen-binding fragment thereof recognizing C5. In one preferred embodiment, the antibody or antigen-binding fragment thereof is eculizumab (Soliris®), pexelizumab, or a biosimilar equivalent to eculizumab or pexelizumab. In one embodiment, the antibody or antigen-binding fragment thereof binds to the cleavage site of C5 and thereby inhibits cleavage of C5 by preventing the C5 convertase from accessing the cleavage site in C5. In one embodiment, the adverse clinical events associated with discontinuation comprise thrombotic microangiopathy (TMA) or a TMA-related complication. In one preferred embodiment, the TMA-related complication is selected from the group consisting of: changes in mental status, seizures, angina, dyspnea, and thrombosis. In another preferred embodiment, the TMA-related complication can be identified by comparing two or more measurements of a laboratory parameter selected from the group consisting of: platelet count, serum creatinine level, and serum LDH level. In one embodiment, a TMA-related complication is indicated by:

i) a 25% or greater decrease in platelet count compared to baseline or the peak platelet count during treatment;

ii) an increase of 25% or greater in serum creatinine level compared to baseline or nadir during treatment; or

iii) an increase of 25% or greater in serum LDH level compared to baseline or nadir during treatment.

In another aspect, the present disclosure provides a method for distributing a complement inhibitor (CI1) for use in treating a patient: (i) afflicted with, suspected of having, or at risk for developing a complement-associated disorder, and (ii) in need of treatment with the complement inhibitor, the method comprising:

i) authorizing distribution of a complement inhibitor to a physician or a pharmacy who will further distribute the inhibitor to the patient, upon certification from the physician or pharmacy that:
(a) the physician or pharmacy has received one or both of verbal and written warning as to the risk of adverse clinical events associated with discontinuing use of the complement inhibitor to treat the disorder; and
(b) the physician or pharmacy will distribute the warning to the patient, or the legal guardian or representative of the patient;

ii) registering via a computer readable medium a database comprising the information that the physician or pharmacy has received and acknowledged the warning and agreed to distributing the warning to the patient, or the legal guardian or representative of the patient; and

iii) following (i) and (ii), distributing the complement inhibitor to the physician or pharmacy for use in treating the patient.

In another aspect, the present disclosure provides a method of creating a database of physicians or pharmacies who will distribute a complement inhibitor (CI1) for use in treating a complement-associated disorder, wherein said method comprises registering via a computer readable medium a database containing information that the physicians or pharmacies have received and acknowledged one or both of verbal and written warning as to the risk of adverse clinical events associated with discontinuing use of a complement inhibitor to treat the disorder and agreed to distributing the warning to the patient who has the disorder, or the legal guardian or representative of the patient.

In some embodiments, the complement-associated disorder disclosed herein is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD).

In another aspect, the present disclosure provides a database of physicians or pharmacies created by the methods disclosed herein.

In another aspect, the present disclosure provides a system for distributing a complement inhibitor (CI1) for use in treating a patient: (i) afflicted with, suspected of having, or at risk for developing a complement-associated disorder, and (ii) in need of treatment with the complement inhibitor, the system comprising:

a memory or a storage device for storing information about the patient and about whether an instruction to distribute the complement inhibitor is executed; and

a processor configured to execute the instruction,

wherein the instruction causes the processor to perform the steps comprising:

i) searching the memory or storage device for certifications that:
(a) the patient, or the legal guardian or representative of the patient, is competent to comprehend and assess information and to make decisions;
(b) the patient, or the legal guardian or representative of the patient, has received one or both of verbal and written warning as to the risk of adverse clinical events associated with discontinuing use of the complement inhibitor to treat the disorder; and
(c) the patient, or the legal guardian or representative of the patient, has expressed acknowledgment of the warning and agreement to the treatment;

ii) upon the identification of certifications in step i), authorizing distribution of the complement inhibitor to treat the patient; and

iii) registering via the memory or storage device the distribution of the complement inhibitor.

In some embodiments, the disorder is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD).

In some embodiments, the information stored in the memory or storage device disclosed herein further comprises the information concerning the patient's discontinuing use of the complement inhibitor (CI1) and that the patient is monitored for adverse clinical events after the discontinuation. In other embodiments, the information stored in the memory or storage device disclosed herein further comprises that the patient is treated by re-initiation of the complement inhibitor (CI1) treatment or with an alternative therapy to treat the adverse clinical events after discontinuing use of the complement inhibitor (CI1). In one embodiment, the alternative therapy comprises treating with a different complement inhibitor (CI2) or with a different regimen of the same complement inhibitor (CI1). In another embodiment, the alternative therapy comprises plasma therapy, or organ-specific supportive measures, or a combination thereof. For example, the plasma therapy disclosed herein is selected from the group consisting of: plasmapheresis, plasma exchange, and fresh frozen plasma infusion. In some embodiments, the complement inhibitor (CI1) disclosed herein is an inhibitor of complement protein C5. In one embodiment, the complement inhibitor (CI1) is an antibody or antigen-binding fragment thereof recognizing C5. For example, the antibody or antigen-binding fragment thereof includes at least eculizumab (Soliris®), pexelizumab, or a biosimilar equivalent of eculizumab or pexelizumab. In some embodiments, the adverse clinical events associated with discontinuation disclosed herein comprise thrombotic microangiopathy (TMA) or a TMA-related complication. In one embodiment, the TMA-related complication is selected from the group consisting of: changes in mental status, seizures, angina, dyspnea, and thrombosis. In another embodiment, the TMA-related complication is identified by comparing two or more measurements of a laboratory parameter, said laboratory parameter being selected from the group consisting of: platelet count, serum creatinine, and serum LDH. For example, a TMA-related complication is indicated by:

i) a 25% or greater decrease in platelet count compared to baseline or the peak platelet count during treatment;

ii) an increase of 25% or greater in serum creatinine compared to baseline or nadir during treatment; or

iii) an increase of 25% or greater in serum LDH compared to baseline or nadir during treatment.

In some embodiments, the information stored in the memory or storage device disclosed herein is created into a database. In some embodiments, the information stored in the memory or storage device is to be reported to a government regulatory agency. In one embodiment, the complement inhibitor is distributed after obtaining an approval from the government regulatory agency.

In some embodiments, the information stored in the memory or storage device further comprises that the complement inhibitor is distributed with a document providing a warning about at least one potential adverse clinical event after discontinuing use of the complement inhibitor (CI1).

### DETAILED DESCRIPTION OF THE DISCLOSURE

The present disclosure is directed generally to methods for the delivery of drugs, especially drugs inhibiting complement activation pathways, to patients. The term “drug,” as used herein, refers to any substance which is intended for use in the diagnosis, cure, mitigation, treatment or prevention of disease, or to affect the structure or function of the body. Generally speaking, the methods of the present disclosure may be desirably and advantageously used to educate and reinforce the actions and behaviors of patients who are taking the drug, as well as prescribers who prescribe the drug and pharmacies which dispense the drug. Such education and reinforcement of actions and behavior are often necessary to ensure proper prescribing and dispensing of the drug, as well as patient compliance with taking the drug. In certain cases it is also necessary to educate patients and prescribers concerning discontinuation of the drug. Discontinuation of a drug may lead to harmful effects and the patient and prescriber need to be educated as to what these harmful effects may be, how to monitor for harmful effects, and how to treat the patient if harmful effects are seen upon discontinuation. A wide variety of educational materials may be employed to ensure proper prescribing, dispensing, patient compliance and follow-up observation according to the methods described herein, including, for example, a variety of literature and other materials, such as, for example, product information, package inserts, educational brochures, continuing education monographs, videotapes and the like which may describe the risks and benefits associated with taking and/or discontinuing the particular drug.

The methods described herein may be advantageously employed for the distribution of a complement inhibitor to a patient. As used herein, the term “complement inhibitor” refers to any agent (e.g., any nucleic acids, amino acids, polynucleotides, polypeptides, proteins, chemical compounds, etc.) which is capable of at least partially reducing, neutralizing, antagonizing or completely inhibiting the activation of complement activation pathways, e.g., the classical pathway, the alternative pathway, and the lectin pathway. Thus, the complement inhibitor in this application can be any inhibitor that antagonizes any component in the complement activation pathways, resulting in a decreased level of downstream complement activation products. For example, a complement inhibitor may generally and broadly inhibit the complement activation at the level of C1 esterase, C3, or selectively block C5 activation with subsequent inhibition of C5a and C5b-9 (TCC) formation. One non-limiting example of such inhibitors is an antibody or antigen-binding fragment thereof or antigen-binding polypeptide which binds to the cleavage site of C5 and thereby inhibits cleavage of C5 by preventing the C5 convertase from accessing the cleavage site in C5. Such inhibitors also include an antibody or antigen-binding fragment thereof or antigen-binding polypeptide which binds to C5a or C5b fragment and inhibits their activities. Another non-limiting example is an antibody or antigen-binding fragment thereof which binds to C5 at a site other than the cleavage site but prevents cleavage of C5. The antibodies eculizumab and pexelizumab are examples of such antibodies. Other complement inhibitors may antagonize or inhibit activators of complement pathways. One non-limiting example of such inhibitors is an antibody, antigen-binding fragment, antigen-binding polypeptide, or agent which recognizes and inhibits factor B or factor D. Some naturally occurring regulators include, for example, C1 inhibitors, complement receptor 1 (CR1/CD35), complement receptor 2 (CR2/CD21), membrane cofactor protein (MCP/CD46), decay-accelerating factor (DAF/CD55), factor I, factor H, C4BP, complement receptor 1 related gene/protein (Crry), CD59, microbial proteins, etc. Recombinant regulators may also be designed based on the natural regulators. For example, soluble proteins (e.g., soluble CR1, DAF, CD59, etc.), tagged proteins (e.g., with a glycosylphosphatidylinositol (GPI) anchor for specific targeting to cell surface), or fusion proteins comprising at least one regulator can be constructed and prepared using well-known methods in the art. Dominant negative proteins (e.g., containing a dominant negative mutation or truncation) of natural regulators can also be used as inhibitors of the corresponding endogenous proteins. Furthermore, chimeric proteins containing at least one inhibitor and at least one other agent (e.g., an agent as a targeting moiety for a specific cell/tissue type or to increase the stability or efficacy of the chimeric protein) could be constructed. In some embodiments, the recombinant complement inhibitor is an antibody or antigen-binding fragment thereof specifically recognizing at least one complement pathway component, such as, for example, mannose-binding lectin (MBL), C1, C3, C3 convertase, C5, C5 convertase, C5a, C5b-9 (TCC), factor D, factor B, etc. Such specific recognizing and binding by complement inhibitors may lead to an inhibition of the activation of certain complement pathway components or the formation of various species, such as certain protein complexes. The complement inhibitor of this application also includes small molecule inhibitors, for example, C1 binding peptides, compstatin, C3 aR antagonists, C5aR antagonists, other small molecule inhibitors of complement components, etc. For a detailed discussion of possible complement inhibitors, see Mollnes and Kirschfink, 2006. Strategies of therapeutic complement inhibition. Molecular Immunology 43: 107-121, the whole content of which is incorporated herein by reference.

In some preferred embodiments, the complement inhibitor is an antibody or antigen-binding fragment thereof specifically recognizing C5. In one embodiment, the antibody or antigen-binding fragment thereof is the mouse anti-C5 monoclonal antibody BB5.1 (Frei et al., 1987. Generation of a monoclonal antibody to mouse C5 application in an ELISA assay for detection of anti-C5 antibodies. Mol. Cell. Probes 1: 141-149), the humanized anti-C5 single chain fragment h5G1.1-scFv (i.e., pexelizumab, Alexion Pharmaceuticals, Cheshire, Conn.), or the humanized anti-C5 monoclonal antibody eculizumab (with the commercial name Soliris®, Alexion Pharmaceuticals, Inc.), or an antigen-binding fragment thereof. Other C5 binding molecules and anti-C5 antibodies useful as complement inhibitors of the present disclosure include, for example, C5 binding molecules and anti-C5 antibodies described in the U.S. Patent Application Publication Nos. 20100034809 and 20100166748, in U.S. Pat. No. 7,999,081, and in Würzner et al. ((1991). Inhibition of terminal complement complex formation and cell lysis by monoclonal antibodies. Complement Inflamm. 8:328-340). In one preferred embodiment, the complement inhibitor is a polypeptide comprising an amino acid sequence with at least about 50% (e.g., 50, 55, 60, 65, 70, 75, 80, 85, 90, 95, or above 95%) homology (similarity) or identity with that of the instantly disclosed antibody or antigen-binding fragment thereof or antigen-binding polypeptide (e.g., eculizumab or pexelizumab). In another preferred embodiment, the complement inhibitor comprises an amino acid sequence with at least about 75% homology or identity therewith. The complement inhibitor may comprise in other instances an amino acid sequence with at least about 80% homology or identity therewith and in other embodiments at least about 85%, 90% or 95% homology or identity therewith. While the term “complement activation” or similar terms used herein in general refers to the activation of at least one of the complement pathways and at least one of the downstream complement components, the term “inhibiting complement activation by antagonizing C5” or similar terms used herein specifically refers to inhibiting the cleavage of C5 into C5a and C5b by C5 convertase and inhibiting downstream C5b-9 complex formation or inhibiting the formation of C5a or the activity of C5a.

The complement inhibitor featured in the disclosure is designed for treating or preventing a complement-associated disorder. The method involves administering to a subject (e.g., a human) in need thereof a therapeutic complement inhibitor (e.g., an antibody or antigen-binding fragment thereof) described herein in an amount sufficient to treat a complement-associated disorder afflicting the subject. The complement-associated disorder can be, e.g., a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), or sepsis. In some embodiments, the complement-associated disorder is a complement-associated pulmonary disorder. For example, the complement-associated pulmonary disorder can be, e.g., asthma or chronic obstructive pulmonary disease (COPD). Other complement-associated disorders amenable to treatment or prevention are described herein. The mode of administration, which can vary depending on the type of complement-associated disorder to be treated, can be, e.g., intravenous administration, intrapulmonary administration, intraocular administration, subcutaneous administration, or intraarticular administration.

In some embodiments, the complement inhibitor featured in the disclosure can be performed in conjunction with other therapies for complement-associated disorders. For example, the composition can be administered to a subject at the same time, prior to, or after, plasmapheresis, IVIG therapy, or plasma exchange. See, e.g., Appel et al. (2005) J Am Soc Nephrol 16:1392-1404. In some embodiments, the complement inhibitor can be administered to a subject at the same time, prior to, or after, a kidney transplant.

A “subject,” as used herein, is a human. In some embodiments, the subject is an infant, adolescent, or adult.

As used herein, a subject “in need of prevention,” “in need of treatment,” or “in need thereof,” refers to one, who by the judgment of an appropriate medical practitioner (e.g., a doctor, a nurse, or a nurse practitioner in the case of humans; a veterinarian in the case of non-human mammals), would reasonably benefit from a given treatment (such as treatment with a composition comprising an anti-C5 antibody or antigen-binding fragment thereof).

The term “preventing” is art-recognized, and when used in relation to a condition, is well understood in the art, and includes administration of a composition which reduces the frequency of, or delays the onset of, symptoms of a medical condition in a subject relative to a subject which does not receive the composition. Thus, prevention of a complement-associated disorder such as asthma includes, for example, reducing the extent or frequency of coughing, wheezing, or chest pain in a population of patients receiving a prophylactic treatment relative to an untreated control population, and/or delaying the occurrence of coughing or wheezing in a treated population versus an untreated control population, e.g., by a statistically and/or clinically significant amount.

The terms “therapeutically effective amount” or “therapeutically effective dose,” or similar terms used herein are intended to mean an amount of an agent (e.g., a complement inhibitor) that will elicit the desired biological or medical response (e.g., an improvement in one or more symptoms of a complement-associated disorder).

The term “patient certification” is intended to mean that (a) the patient, or the legal guardian or representative of the patient, is competent to comprehend and assess information and to make decisions; (b) the patient, or the legal guardian or representative of the patient, has received one or both of verbal and written warning as to the risk of adverse clinical events associated with discontinuing use of the complement inhibitor to treat the disorder; and (c) the patient, or the legal guardian or representative of the patient, has acknowledged the warning and agreement to the treatment.

As used throughout the present disclosure, the term “antibody” refers to a whole or intact antibody (e.g., IgM, IgG, IgA, IgD, or IgE) molecule that is generated by any one of a variety of methods that are known in the art and described herein. The term “antibody” includes a polyclonal antibody, a monoclonal antibody, a chimerized or chimeric antibody, a humanized antibody, a deimmunized human antibody, and a fully human antibody. The antibody can be made in or derived from any of a variety of species, e.g., mammals such as humans, non-human primates (e.g., monkeys, baboons, or chimpanzees), horses, cattle, pigs, sheep, goats, dogs, cats, rabbits, guinea pigs, gerbils, hamsters, rats, and mice. The antibody can be a purified or a recombinant antibody.

As used herein, the term “antibody fragment,” “antigen-binding fragment,” or similar terms refer to a fragment of an antibody that retains the ability to bind to an antigen, e.g., a single chain antibody (scFv), an Fd fragment, an Fab fragment, an Fab′ fragment, or an F(ab′)₂ fragment. An scFv is a single polypeptide chain that includes both the heavy and light chain variable regions of the antibody from which the scFv is derived. In addition, diabodies (Poljak (1994) Structure 2(12):1121-1123; Hudson et al. (1999) J Immunol Methods 23(1-2):177-189, the disclosures of both of which are incorporated herein by reference in their entirety), minibodies, triabodies (Schoonooghe et al. (2009) BMC Biotechnol 9:70), domain antibodies (also known as “heavy chain immunoglobulins” or camelids; Holt et al. (2003) Trends Biotechnol 21(11):484-490); and intrabodies (Huston et al. (2001) Hum Antibodies 10(3-4):127-142; Wheeler et al. (2003) Mol Ther 8(3):355-366; Stocks (2004) Drug Discov Today 9(22): 960-966, the disclosures of each of which are incorporated herein by reference in their entirety) are included in the definition of antibody fragments and can be incorporated into the compositions, and used in the methods, described herein.

The antibodies and fragments thereof identified herein can be or can be made “chimeric.” Chimeric antibodies and antigen-binding fragments thereof comprise portions from two or more different species (e.g., mouse and human). Chimeric antibodies can be produced with mouse variable regions of desired specificity fused to human constant domains (for example, U.S. Pat. No. 4,816,567). In this manner, non-human antibodies can be modified to make them more suitable for human clinical application (e.g., methods for treating or preventing a complement-mediated disorder in a subject).

The monoclonal antibodies of the present disclosure include “humanized” forms of the non-human (e.g., mouse) antibodies. Humanized or CDR-grafted mAbs are particularly useful as therapeutic agents for humans because they are not cleared from the circulation as rapidly as mouse antibodies and do not typically provoke an adverse immune reaction. Generally, a humanized antibody has one or more amino acid residues introduced into it from a non-human source. These non-human amino acid residues are often referred to as “import” residues, which are typically taken from an “import” variable domain. Methods of preparing humanized antibodies are generally well known in the art.

As described above, the antibodies and biologically-active fragments described herein can be used to treat a variety of complement-associated disorders such as, but not limited to: rheumatoid arthritis (RA); lupus nephritis; ischemia-reperfusion injury; paroxysmal nocturnal hemoglobinuria (PNH), atypical hemolytic uremic syndrome (aHUS); typical or infectious hemolytic uremic syndrome (tHUS); myasthenia gravis (MG); neuromyelitis optica (NMO); antiphospholipid syndrome (APS); Degos disease; catastrophic APS (CAPS); dense deposit disease (DDD); scleroderma; multiple sclerosis (MS); macular degeneration (e.g., age-related macular degeneration (AMD)); hemolysis, elevated liver enzymes, and low platelets (HELLP) syndrome; sepsis; dermatomyositis; diabetic retinopathy; thrombotic thrombocytopenic purpura (TTP); spontaneous fetal loss; Pauci-immune vasculitis; epidermolysis bullosa; recurrent fetal loss; multiple sclerosis (MS); and traumatic brain injury. See, e.g., Holers (2008) Immunological Reviews 223:300-316 and Holers and Thurman (2004) Molecular Immunology 41:147-152. Also see PCT Publication No. WO2010/054403. In some embodiments, the complement-mediated disorder is a complement-mediated vascular disorder such as, but not limited to, a cardiovascular disorder, myocarditis, a cerebrovascular disorder, a peripheral (e.g., musculoskeletal) vascular disorder, a renovascular disorder, a mesenteric/enteric vascular disorder, revascularization to transplants and/or replants, vasculitis, Henoch-Schönlein purpura nephritis, systemic lupus erythematosus-associated vasculitis, vasculitis associated with rheumatoid arthritis, immune complex vasculitis, Takayasu's disease, capillary leak syndrome, dilated cardiomyopathy, diabetic angiopathy, thoracic-abdominal aortic aneurysm, Kawasaki's disease (arteritis), venous gas embolus (VGE), and restenosis following stent placement, rotational atherectomy, and percutaneous transluminal coronary angioplasty (PTCA). (See, e.g., U.S. Pat. No. 7,919,094) In some embodiments, the complement-associated disorder is myasthenia gravis, cold-agglutinin disease (CAD), paroxysmal cold hemoglobinuria (PCH), dermatomyositis, scleroderma, warm autoimmune hemolytic anemia, Graves' disease, Hashimoto's thyroiditis, type I diabetes, psoriasis, pemphigus, autoimmune hemolytic anemia (AIHA), idiopathic thrombocytopenic purpura (ITP), Goodpasture syndrome, myasthenia gravis (MG), neuromyelitis optica (NMO), antiphospholipid syndrome (APS), Degos disease, and catastrophic APS (CAPS).

In some embodiments, the complement inhibitor described herein, alone or in combination with a second anti-inflammatory agent, can be used to treat an inflammatory disorder such as, but not limited to, RA (above), inflammatory bowel disease, sepsis (above), septic shock, acute lung injury, disseminated intravascular coagulation (DIC), or Crohn's disease. In some embodiments, the second anti-inflammatory agent can be one selected from the group consisting of nonsteroidal anti-inflammatory drugs (NSAIDs), corticosteroids, methotrexate, hydroxychloroquine, anti-TNF agents such as etanercept and infliximab, a B cell depleting agent such as rituximab, an interleukin-1 antagonist, or a T cell costimulatory blocking agent such as abatacept (marketed as Orencia® by Bristol-Myers Squibb, New York, N.Y.).

In some embodiments, the complement-associated disorder is a complement-associated neurological disorder such as, but not limited to, amyotrophic lateral sclerosis (ALS), brain injury, Alzheimer's disease, myasthenia gravis (MG), neuromyelitis optica (NMO), and chronic inflammatory demyelinating neuropathy.

Complement-associated disorders also include complement-associated pulmonary disorders such as, but not limited to, asthma, bronchitis, a chronic obstructive pulmonary disease (COPD), an interstitial lung disease, α-1 anti-trypsin deficiency, emphysema, bronchiectasis, bronchiolitis obliterans, diffuse interstitial lung disease, alveolitis, sarcoidosis, pulmonary fibrosis, and collagen vascular disorders.

In one aspect, the disclosure features treating a patient with the complement inhibitor described herein (e.g., an anti-C5 antibody or antigen-binding fragment thereof), wherein the patient is: (i) afflicted with, suspected of having, or at risk for developing a complement-associated disorder (e.g., PNH or aHUS); and (ii) in need of treatment.

Patients suspected of having or at risk for developing a complement-associated disorder (e.g., PNH or aHUS) can be determined by analyzing the corresponding risk factors of the disorder. For example, PNH is a debilitating and life-threatening disorder characterized by genetic mutations in hematopoietic stem cells leading to uncontrolled complement activation causing chronic intravascular hemolysis and an inflammatory prothrombotic state. PNH evolves from the clonal expansion of hematopoietic stem cells harboring a somatic mutation causing complete or marked loss of the GPI-linked terminal complement inhibitor DAF/CD55 and CD59 from the surface of hematopoietic cells, rendering red blood cells (RBCs) highly susceptible to uncontrolled terminal complement-mediated hemolysis, and white blood cells and platelets to uncontrolled complement-mediated cell activation. The destruction and loss of these abnormal RBCs (intravascular hemolysis) results in low RBC counts (anemia), and also fatigue, difficulty in functioning, pain, dark urine, shortness of breath, and blood clots. Similarly, aHUS is a complement inhibitor deficiency disorder characterized by uncontrolled complement activation, resulting in platelet activation and endothelial cell damage. As a very rare, serious and life-threatening disorder, aHUS is characterized as a thrombotic microangiopathic disease (TMA), which includes a triad of thrombotic thrombocytopenia, microangiopathic hemolysis and impaired renal function as well as other ischemic complications. In patients with aHUS, their kidney and blood cells, including platelets, can be inflamed which can lead to low blood counts (thrombocytopenia and anemia), reduced or lost kidney function, blood clots, tiredness and difficulty in functioning. Most cases of aHUS are secondary to mutations in genes which encode components of the alternative pathway of the complement cascade. Similar to observations in PNH, uncontrolled complement activation may contribute to the TMA process in aHUS by causing inflammation and prothrombotic activity. Patients with aHUS currently face a very poor prognosis with high likelihood of kidney failure, dialysis and/or death within one year from the time of diagnosis unless treated with a complement inhibitor such as Soliris®. While aHUS is a very rare disorder, the incidence of aHUS has been poorly characterized. From the sparse epidemiologic data in the literature, reports indicate that most patients develop the disease before 10 years of age. See Loirat et al. (Complement and the atypical hemolytic uremic syndrome in children. Pediatr Nephrol 2008, 23(11):1957-72). Data derived from the European HUS registry indicate that only 167 patients have been identified across all of Europe, and prevalence was estimated at approximately 3 per million in children less than 18 years of age. See Zimmerhackl et al. (Epidemiology, clinical presentation, and pathophysiology of atypical and recurrent hemolytic uremic syndrome. Semin. Thromb. Hemost. 2006, 32(2):113-20). The prevalence in adults is expected to be lower. In approximately half of aHUS cases mutations have been identified in the alternative pathway of the complement cascade, including mutations in genes encoding complement regulatory proteins (e.g., factor H (FH), MCP, factor I, factor B and C3, etc.) and/or patients with the presence of neutralizing antibodies to these proteins. Mutations have been identified in at least 10 different genes to date. Because of the heterogeneity of different complement defects contributing to clinically severe aHUS, and because only approximately 50% of aHUS patients have observed mutations, identification of a specific mutation is not required for aHUS diagnosis. See Noris and Remuzzi (Atypical hemolytic-uremic syndrome. N Engl J Med 2009, 361:1676-87). For example, factor H abnormalities are the most frequent mutation found in about 30% of patients with gene mutations. Most patients with factor H mutations develop end-stage renal failure (ESRF) and a recurrence rate posttransplant of about 80%. See Kavanagh et al. (Atypical haemolytic uraemic syndrome. Br Med Bull 2006, 77:1-18) and Zimmerhackl et al. (Renal transplantation in HUS patients with disorders of complement regulation. Pediatr Nephrol 2007, 22:10-16).

While many aHUS patients report a prodrome of feeling unwell, including fever, malaise, diarrhea, abdominal pain, nausea, vomiting, or neurologic symptoms, aHUS patients are generally only clinically identified when they present with an abrupt onset of signs and symptoms. If they survive this initial disease presentation, they are typically burdened with a chronic thrombotic and inflammatory state characterized by platelet and endothelial cell activation which carries a life-long elevated risk of sudden blood clotting, renal insufficiency with ensuring dialysis, and other severe complications of TMA. Severe TMA complications in aHUS patients, in addition to renal TMA complications, include seizures, CNS infarcts, coma, cardiomyopathy, myocardial infarction, pancreatitis, pulmonary distress, diffuse vasculopathy, and multi-organ TMA. These complications frequently lead to premature mortality in aHUS.

Until recently there were very limited treatment options for aHUS patients. Therapy was empirical and aimed primarily at stabilizing the patient and mitigating irreversible kidney damage through the use mostly of plasma therapy (PT) and could include the use of immunosuppressant drugs and supportive care. The rationale for the use of PT in aHUS patients is to remove plasma, which contains mutated complement regulatory proteins or auto-antibodies to complement regulatory proteins, and replace it with fresh frozen plasma from healthy donors in an attempt to transiently restore control of complement activity. However, there are limited data which support the long-term benefit of PT and no controlled clinical trials have been performed to establish its safety or efficacy in aHUS patients. In addition, PT is a laborious procedure leading to a poor quality of life for patients who receive it. It is also associated with a risk of infection, allergic reactions, thrombosis, and loss of vascular access and provides incomplete reversal of TMA. Kidney transplant has been undertaken in aHUS patients; however, despite the best supportive care, recurrent aHUS causes kidney transplant failure in up to approximately 60 to 90 percent of patients.

Recently eculizumab (Soliris®, Alexion Pharmaceuticals, Inc.), a humanized monoclonal antibody specifically recognizing human complement protein C5 and preventing the cleavage of C5 and the formation of C5a and the C5b-9 terminal complex, has been demonstrated to be effective in treating PNH and aHUS patients. To date it has been approved in both the U.S.A. and Europe to treat aHUS patients.

Adverse effects resulting from complement inhibition may be directly related to the function of complement, i.e., increased susceptibility to infection and autoimmune- and immune-complex diseases, arising from impaired opsonization, adaptive immune response, tolerance or elimination of immune-complexes. The risk of infectious complications is most probably highest when blocking C3. Blocking of C5b-9 formation, however, could lead to increased susceptibility to certain pathogens, such as Neisseriae. In addition, Gram-negative septic shock may result from complement inhibition, while treatment with antibiotics would compensate for short-term complement inhibition.

For Soliris®, meningococcal infections are the most important adverse reactions experienced by patients while on the drug. In PNH clinical studies, the use of Soliris® increases a patient's susceptibility to serious meningococcal infections (septicemia and/or meningitis). The risk groups or the most known risk factors include: 1) genetic deficiency or therapeutic inhibition of terminal complement (such as Soliris® therapy); 2) lack of commercially available vaccine against meningococcus serogroup B; and 3) delay or absence of appropriate medical consultation at the appearance of first symptoms. The occurrence of meningococcal infection can be prevented in some cases by means of meningococcal vaccines. For example, patients without a history of meningococcal vaccination can be vaccinated at least 2 weeks prior to receiving the first dose of Soliris or other complement inhibitor. If urgent Soliris® therapy is indicated in an unvaccinated patient, the meningococcal vaccine should be administered as soon as possible. In patients who cannot receive meningococcal vaccine, including children below the age of two years, antibiotic prophylaxis could prevent meningococcal infection. However, meningococcal vaccination reduces, but does not eliminate, the risk of meningococcal infections. In addition, available meningococcal vaccines do not cover all serogroups, notably serogroup B infection. In clinical studies, 2 out of 196 PNH patients developed serious meningococcal infections while receiving treatment with Soliris®, both of whom had been vaccinated. In clinical studies among non-PNH patients, meningococcal meningitis occurred in one unvaccinated patient. In addition, a previously vaccinated patient with aHUS developed meningococcal sepsis during the post-study follow-up period.

Since anti-C5 antibodies or antigen-binding fragments (e.g., eculizumab and pexelizumab) block terminal complement activation, patients treated with these agents (e.g., eculizumab/Soliris®) may have increased susceptibility to infections in addition to meningococcal infections, especially with encapsulated bacteria. For example, children or adolescent patients may be at increased risk of developing serious infections due to Streptococcus pneumonia and Haemophilus influenza type b (Hib). In clinical studies, a total of 11 out of 195 PNH patients experienced an infection-related serious adverse event (SAE) with eculizumab treatment, including Cellulitis (1 patient), Haemophilus infection (1 patient), other infection (1 patient), Meningococcal sepsis (2 patients), Necrotizing fasciitis (1 patient), respiratory tract infection (1 patient), urinary tract infection (1 patient), viral infection (2 patients), and viral upper respiratory tract infection (1 patient). One out of 37 aHUS patients treated with eculizumab was found to have peritonitis. Correspondingly, vaccinations for the prevention of these infections should be administered prior to the treatment by terminal complement C5 inhibition.

The Soliris® therapy has been found to increase the number of PNH cells. Actually, the proportion of PNH RBCs increased among Soliris®-treated PNH patients by a median of 28% from baseline (range from −25% to 69%). Thus, PNH patients who discontinue treatment with Soliris® may be at increased risk for serious hemolysis. Serious hemolysis is identified by serum lactic dehydrogenase (LDH) levels greater than the pre-treatment level, along with any of the following: greater than 25% absolute decrease in PNH clone size (in the absence of dilution due to transfusion) in one week or less; a hemoglobin level of <5 gm/dL or a decrease of >4 gm/dL in one week or less; angina; change in mental status; a 50% increase in serum creatinine level; or thrombosis. Therefore, any PNH patient who discontinues Soliris® should be monitored for at least 8 weeks to detect serious hemolysis and other reactions. If serious hemolysis occurs after Soliris® discontinuation, consider the following procedures/treatments: blood transfusion (packed RBCs), or exchange transfusion (if the PNH RBCs are >50% of the total RBCs) by flow cytometry; anticoagulation; corticosteroids; or reinstitution of Soliris®. In clinical studies, 16 of 196 PNH patients discontinued treatment with Soliris®. Patients were followed for evidence of worsening hemolysis and no serious hemolysis was observed.

Disclosed herein is an unexpected discovery that some types of adverse reactions, including some severe ones, occur after discontinuation of the treatment of aHUS patients by inhibiting terminal complement C5. For example, severe thrombotic microangiopathy (TMA) complications were observed after Soliris® discontinuation in aHUS clinical studies. The reported severe TMA complications after drug discontinuation included: 1) graft failure requiring dialysis; 2) renal insufficiency; 3) end stage renal disease; 4) respiratory distress requiring intubation; 5) diarrhea and increased renal insufficiency; and 6) nephrotic syndrome and renal insufficiency. Severe TMA complications post discontinuation were identified by (i) any two or more measurements of any one of the following: a decrease in platelet count of 25% or more as compared to either baseline or to peak platelet count during eculizumab treatment; an increase in serum creatinine of 25% or more as compared to baseline or to nadir during eculizumab treatment; or, an increase in serum LDH of 25% or more as compared to baseline or to nadir during eculizumab treatment; or (ii) any one of the following: a change in mental status or seizures; angina or dyspnea; or thrombosis. In aHUS clinical studies, 18 patients (5 in the prospective studies) discontinued Soliris® treatment. Seven (7) severe TMA complications were observed following the discontinuation of Soliris® in 5 patients at a median of 33 days (range 27-80 days) following the last dose. Soliris® treatment was re-initiated in 4 of these 5 patients. However, no fatalities were reported in the aHUS clinical trials as result of severe TMA complications.

Additionally, similar TMA complications post discontinuation have now been seen in patients enrolled in clinical trials evaluating the use of Soliris® to treat patients who have NMO or MG.

The term “baseline” for different laboratory parameters used in the present disclosure is the last value available for the patient prior to initiation of treatment.

Some clinical parameters may be helpful for laboratory monitoring of PNH and aHUS with or without Soliris® treatment. For example, for PNH, serum LDH levels increase during hemolysis and may assist in monitoring Soliris® effects, including the response to discontinuation of therapy. In clinical studies, six patients achieved a reduction in serum LDH levels only after a decrease in the Soliris® dosing interval from 14 to 12 days. All other patients achieved a reduction in serum LDH levels with the 14 day dosing interval. For aHUS, early signs of thrombotic microangiopathy (TMA) include a decrease in platelet count, and increases in serum LDH and creatinine levels. Thus, patients should be followed for signs of TMA by monitoring the above laboratory parameters during Soliris® therapy and/or therapy discontinuation.

If TMA complications occur after Soliris® discontinuation, the re-initiation of the drug, with the same or a different regimen (e.g., dosage, injection method and frequency, etc.) should be considered. In addition, other available therapies include, for example, plasma therapy (e.g., plasmapheresis, plasma exchange, fresh frozen plasma infusion, etc.) or appropriate organ-specific supportive measures.

For safety concerns, pharmacovigilance has to be maintained for aHUS patients. For example, aHUS patients will be registered into a database and information regarding their risk factors (e.g., laboratory parameters regarding aHUS symptoms, related diseases, adverse reactions during therapy or after therapy discontinuation, therapy regimens, adverse events or state of well-being) may be collected. The information in the database may be updated, if necessary, and provided, if necessary, to any drug manufacturer, supplier, prescriber, aHUS patient (or the patient's legal guardian, representative, or supervising practitioner) as well as regulatory authorities.

The drug-distributing methods of the present disclosure preferably involve, inter alia, registering in a computer readable storage medium prescribers who are qualified to prescribe the involved complement inhibitor drugs including, for example, eculizumab (Soliris®), pexelizumab, biosimilar equivalents of eculizumab or pexelizumab, other C5-binding molecules and anti-C5 antibodies or antigen-binding fragments thereof, e.g., those disclosed in U.S. Patent Application Publication Nos. 20100034809 and 20100166748, in U.S. Pat. No. 7,999,081 or in Würzner et al. (Complement Inflamm. 8:328-340 (1991)). Once registered in the computer readable storage medium, the prescriber may be eligible to prescribe the drug to patients in need of the drug. Generally speaking, in order to become registered in the computer readable storage medium, the prescriber may be required to comply with various aspects of the methods described herein including, for example, providing patient education and counseling, and the like, as described in detail below. The registration of the prescriber in the computer readable storage medium may be achieved by providing the prescriber, for example, by hand, mail, facsimile transmission, or on-line transmission, with a registration card or form, preferably together with appropriate educational materials concerning, for example, the particular drug for which the prescriber is being registered to prescribe, as well as suitable methods for delivering the drug to the patient, including the drug delivery methods described herein. The prescriber will preferably complete the registration card or form by providing information requested therein, and the registration card or form will preferably be returned to the manufacturer or distributor of the drug, or other authorized recipient of the registration materials, for example, by hand, mail, facsimile transmission or on-line transmission. Information which may be requested of the prescriber in the registration card or form may include, for example, the prescriber's name, address, and affiliation, if any, with one or more health care institutions. The prescriber's information in the registration card or form is then entered into the computer readable storage medium. It is contemplated that the registration of the prescriber into the computer readable storage medium may also be achieved, for example, by telephone. Suitable computer readable storage media which may be employed for registration of the prescribers (as well as the pharmacies and patients, as discussed herein) will be apparent to one of ordinary skill in the art, once armed with the teachings of the present application.

In accordance with the methods described herein, pharmacies which may fill prescriptions for the particular drug being prescribed herein are also preferably registered in a computer readable storage medium. The computer readable storage medium in which the pharmacies are registered may be the same as, or different from the computer readable storage medium in which the prescribers are registered. Once registered in the computer readable storage medium, the pharmacies may be eligible to dispense the involved drug to patients who are in need of the drug. Generally speaking, in order to become registered in the computer readable storage medium, the pharmacy may be required to comply with various aspects of the methods described herein including, for example, registering the patient (preferably also in a computer readable storage medium), as well as other aspects of the present methods, as described in detail below. As with the registration of the prescriber in the computer readable storage medium, the registration of the pharmacy may be achieved by providing the pharmacy, for example, by hand, mail, facsimile transmission, or on-line transmission, with a registration card or form, preferably together with appropriate educational materials concerning, for example, the particular drug for which the pharmacy is being registered to dispense, as well as suitable methods for delivering the drug to the patient, including the drug delivery methods described herein. The pharmacy may then have the registration card or form completed by providing the information requested therein, which thereafter may be returned to the manufacturer or distributor of the drug, or other authorized recipient of the registration card or form, for example, by hand, mail, facsimile transmission or on-line transmission. Information which may be requested of the pharmacy in the registration card or form may include, for example, the pharmacy's name, address, and affiliation, if any, with any health care institution such as, for example, hospital, health care organization, and the like. The pharmacy's information in the registration card or form is then preferably entered into the computer readable storage medium. It is contemplated that the registration of the pharmacy into the computer readable storage medium may also be achieved, for example, by telephone.

As noted above, the drug-distributing methods described herein also preferably involve the registration of the patient in a computer readable storage medium. As discussed below, the registration of the patient is preferably carried out by the registered pharmacy at the time of the patient's initial visit to the pharmacy or by the prescriber if the prescriber obtains the drug and administers it to the patient. The computer readable storage medium in which the patients are registered may be the same as, or different from the computer readable storage medium in which the prescriber and/or pharmacy is registered. Once registered in the computer readable storage medium, the patient in need of a particular complement inhibitor drug including, for example, a particular anti-C5 antibody or antigen-binding fragment thereof, may be eligible to receive the drug. Generally speaking, in order to become registered in the computer readable storage medium, the patient may be required to comply with various aspects of the methods described herein. In preferred forms, the pharmacy or prescriber will typically have a registration form filled out for the patient, which includes information on the patient, such as the patient's name, mailing address, date of birth, and the like. Information on the prescriber or dispensing pharmacy, such as the information described above for the registration thereof, may also be desirably entered on the patient registration form. The completed form may then be forwarded to the manufacturer or distributor of the drug, or other authorized recipients of the registration form by, for example, hand, mail, facsimile transmission or on-line transmission. It is contemplated that the registration of the patient into the computer readable storage medium may also be achieved, for example, by telephone.

In accordance with the methods of the present disclosure, the delivery of the drug to the patient may involve the following steps. As a prelude to prescribing and dispensing the drug to the patient, the prescriber and/or the pharmacy are registered in one or more appropriate computer readable storage media. Suitable computer readable storage media described herein which may be employed for registration will be apparent to one of ordinary skill in the art, once armed with the teachings of the present application. If the prescriber is not registered in the computer readable storage medium, the prescriber will be ineligible to prescribe the drug. Similarly, if the pharmacy is not registered in the computer readable storage medium, the pharmacy will be ineligible to dispense the drug.

In the course of an examination of a patient, including patients suffering from one or more diseases and/or disorders relevant to complement activation such as, for example, PNH or aHUS, the prescriber may determine that the patient's condition would be improved by the administration of a drug described herein, including eculizumab (Soliris®). Prior to prescribing the drug, the prescriber preferably counsels the patient, for example, on the various risks and benefits associated with the drug. For example, the prescriber preferably discusses the benefits associated with taking the drug, while also advising the patient of the various side effects associated therewith. Thus, a patient who may acquire or impart a condition or disease for which the drug is contraindicated is preferably counseled by the prescriber on the dangers associated therewith. For example, in the case of complement inhibitors antagonizing C5 (e.g., eculizumab (Soliris®), pexelizumab, or other anti-C5 antibodies described herein), the prescriber preferably counsels the patient on the dangers of being administered the drug without vaccination against various bacterial-induced infections (e.g., Meningococcal infection) and the dangers of the potential severe hemolysis or severe TMA complications after treatment discontinuation. Such counsel may be provided verbally, as well as in written form. In preferred embodiments, the prescriber provides the patient with literature materials on the drug for which a prescription is contemplated, such as product information, package insert, educational brochures, patient instruction videos, and the like. Thus, in the case of methods involving complement inhibitors, the prescriber preferably provides patients with literature information, for example, in the form of the aforesaid product information, package insert, educational brochures, patient instruction videos, and the like, warning the patient of the effects and/or the adverse effects during the treatment and/or after treatment discontinuation of the inhibitor.

With particular reference to counseling provided in connection with the complement inhibitor drug (e.g., eculizumab (Soliris®), pexelizumab, biosimilar equivalents of eculizumab or pexelizumab, or other anti-C5 antibodies or antigen-binding fragments thereof described herein), the prescriber preferably counsels aHUS patients that have already discontinued inhibitor treatment or will discontinue the treatment in future. If the patient has already discontinued the inhibitor treatment or will soon discontinue the treatment (for example, it is reasonably believed that the patient will discontinue the treatment in 1, 2, 3, 4, 5, 6, 7, or more days, or 1, 2, 3, 4, 5, 6, or more weeks), the prescriber preferably counsels and/or reminds the patient more frequently as the expected discontinuation date approaches or after the actual discontinuation date. Further, the patient is preferably counseled to have his or her risk factors for the adverse effects after discontinuation (e.g., the various laboratory parameters described herein) measured by himself/herself, a professional personnel, an organization, or a facility authorized by the drug supplier, the prescriber, or the distributor (e.g., a nurse, a doctor, a hospital, a medical laboratory, or a pharmacy). The patient is preferably counseled to examine his/her risk factors, more preferably for multiple times or continuously for a reasonable time period, for identification of possible adverse reactions after discontinuation. The drug supplier, the prescriber, and/or the distributor preferably help to provide directions or such professional personnel or organization for measuring the risk factors of the patient, preferably periodically.

Once a patient is diagnosed to have, or reasonably predicted to have (e.g., based on various risk factors or laboratory parameters described herein), at least an adverse effect or reaction after treatment discontinuation, the diagnosis or the reasonable prediction (further including those measured risk factors or laboratory parameters, if any, in support of such diagnosis or prediction) may be registered in a suitable computer readable storage medium, preferably in the same registry of the patient containing his or her previous clinical information. The patient is preferably informed about the diagnostic result or the reasonable prediction (further including those measured risk factors or laboratory parameters, if any, in support of such diagnosis or prediction). Based on the registry of the diagnosis or the reasonable prediction, the patient will be preferably counseled for possible treatments or therapies for the adverse reaction. Such possible treatments or therapies include, for example, re-initiation of the same complement inhibitor treatment or therapy, substitute treatments or therapies with at least one different complement inhibitor or with a different regimen (e.g., a different dosage, injection method or frequency, etc.) of the same inhibitor, or substitute treatments or therapies involving different mechanisms or target molecules causing the disease or the adverse reaction. For example, for any adverse reaction experienced or to be experienced (based on reasonable predictions) by an aHUS patient discontinuing Soliris® treatment, the possible treatments or therapies include, for example, re-initiation of the same Soliris® treatment, a Soliris® treatment with a different regimen, substitute treatments with pexelizumab or a different anti-C5 antibody or antigen-binding fragment thereof or a different complement inhibitor, or substitute therapies including, for example, plasma therapy (e.g., plasmapheresis, plasma exchange, fresh frozen plasma infusion, etc.) or appropriate organ-specific supportive measures. If needed, a combination of the various treatments or therapies can be considered and administered to the patient.

As would be apparent to one of ordinary skill in the art, once armed with the teachings of the present application, one or more aspects of the counseling described above may be applicable, in certain circumstances, for complement-inhibiting drugs other than Soliris® or other anti-C5 antibodies or antigen-binding fragments thereof.

In situations described in the present application referring to counseling a patient, it equally means to counsel the patient or the patient's legal guardian(s) or representative(s), if any. For all the counseling situations, the patient, or the legal guardian(s) or representative(s) of the patient, should be of an age, as well as being in a physical and psychological state, capable of apprehending the counseling correctly and precisely as a normal person should and additionally be legally responsible for his or her own behavior. In addition to receiving counseling on the drug being prescribed, including counseling, for example, on the adverse reactions after treatment discontinuation, and prior to receiving a prescription for the drug, the methods of the present disclosure preferably involve requiring the patient, or the legal guardian(s) or representative(s) of the patient in a case when the patient is too young or not in a physical or psychological state to: 1) apprehend the information correctly and precisely as a normal person should; or 2) be legally responsible for his or her own behaviors, to express acknowledgment of the counseling and the warning of the adverse reactions while using the drug or discontinuing the usage of the drug. Both the counseling itself and the acknowledgement can be in verbal and/or written forms. The counseling may be through on-site consultation, telephone, mail, facsimile transmission, or on-line transmission. The counseling may, for example, when a patient is not directly supervised by a health professional and/or the prescriber, include literature materials on the drug for which a prescription is contemplated, such as product information, package insert, educational brochures, continuing education monographs, and the like. In one preferable embodiment, the content of the counseling is provided in the patient labeling of the drug and is distributed together with the drug. The patient, or the legal guardian(s) or representative(s) of the patient, is expected to express acknowledgement of counseling through on-site acknowledgement, telephone, mail, facsimile transmission, or on-line transmission, while at least one legally acceptable form of acknowledgement (for example, an original signature, an electronic signature, an oath or declaration before a notary, etc.) is submitted. For example, the patient or the patient's legal guardian(s) or representative(s) is expected to fill out an informed consent form which is signed by the prescriber, as well as the patient, or the patient's legal guardian(s) or representative(s). The prescriber should retain a copy of the informed consent form for his/her records. By filling out and signing an informed consent form, the patient, or the patient's legal guardian(s) or representative(s) acknowledges that he/she understands the risks associated with taking the drug or discontinuing the drug. In the informed consent form, the patient, or the patient's legal guardian(s) or representative(s) preferably agrees to behave, or help the patient to behave, in a manner which is consistent with the prescriber's counsel. For example, in cases involving, for example, anti-C5 antibodies or antigen-binding fragments thereof (e.g., Soliris® and pexelizumab), the patient, or the patient's legal guardian(s) or representative(s), may express agreement to do, or agreement to help the patient to do, at least one of the following: i) monitor at least one risk factor or laboratory parameter for adverse reactions after discontinuing drug treatment; 2) report to the drug prescriber (including, if needed, the drug supplier and the drug distributor) the risk factor or laboratory parameter measurements and the time when the treatment discontinued or will be discontinued; and 3) consider and, if needed, agree to re-initiate the same treatment or a substitute treatment or therapy as described herein in case of experiencing or expecting to experience (based on reasonable predictions) at least one adverse reaction after treatment discontinuation.

The counseling described herein is preferably delivered to the patient, or the patient's legal guardian(s) or representative(s), prior to both a new prescription and any future refill prescription. Any drug prescriber, distributor, packer, or authorized dispenser is preferably required to provide such counseling in one or both of verbal and written formats (e.g., in the patient labeling) to the patient, or the legal guardian(s) or representative(s) of the patient, when a new prescription or refill prescription is dispensed. Any drug manufacturer or supplier is preferably further required to: 1) obtain approval from the drug regulatory agency (e.g., the U.S. FDA office or the corresponding governmental office in the country or region where the drug will be distributed) for the counseling which will be provided with the drug; and 2) ensure that the counseling information will be provided in sufficient numbers, or provide the means to produce the counseling information in sufficient numbers, to distributors, packers, and other authorized dispensers to permit these authorized dispensers to provide the counseling information to each prescriber and to each patient, or the legal guardian(s) or representative(s) of the patient, who will receive a drug prescription.

The counseling information or warning described herein, including, for example, the potential risk of adverse effects after discontinuing the complement inhibitor treatment, may be provided by any drug manufacturer, supplier, distributor, prescriber, authorized dispenser, or supervising practitioner (e.g., a licensed doctor or nurse or other practitioner) to any drug manufacturer, supplier, distributor, prescriber, authorized dispenser, supervising professional personnel, or patient who is taking or has a potential to take such drug.

As used herein, the term “prescriber” refers to any individual who is capable of prescribing drugs, including, for example medical doctors or physicians or pharmacies. The term “authorized dispenser” used herein is intended to mean an individual, a facility, or an organization which is licensed, registered, or otherwise permitted by the jurisdiction in which the individual, facility, or organization practices to provide drug products on prescription in the course of professional practice. Authorized dispensers have the ability to authorized distribution of the complement inhibitor once the relevant regulatory agencies approve marketing of the complement inhibitor. The term “dispense to patients” or “prescription is dispensed,” or similar terms used herein are intended to mean the act of delivering a prescription drug to a patient, or the patient's legal guardian(s) or representative(s), either: i) by a licensed practitioner or an agent of a licensed practitioner, either directly or indirectly, for self-administration by the patient, or the patient's legal guardian(s) or representative(s), or outside the licensed practitioner's direct supervision; or ii) by an authorized dispenser or an agent of an authorized dispenser under a lawful prescription of a licensed practitioner.

In one preferred embodiment, such counseling information or warning is provided in the drug label information of the complement inhibitor. Specifically, the prescription drug labeling information is also known as prescribing information, package insert, professional labeling, direction circular, package circular, etc. The term “label” or similar terms used herein are intended to mean a display of written, printed, or graphic matter upon the immediate container of any article or meant to include a package insert; and a requirement made by or under authority of U.S. Code of Federal Regulations and the U.S. Federal Food, Drug, and Cosmetic Act (FD&C Act) that any word, statement, or other information appearing on the label shall not be considered to be complied with unless such word, statement, or other information also appears on the outside container or wrapper, if any there be, of the retail package of such article, or is easily legible through the outside container or wrapper. The term “labeling” or similar terms used herein are intended to mean all labels and other written, printed, or graphic matters (1) upon any article or any of its containers or wrappers, or (2) accompanying such article, e.g., a package insert.

In another preferred embodiment, such counseling information or warning, with or without patient information (e.g., bibliographic information, clinical record, personal and/or family disease and/or therapy record, the risk factors and/or laboratory parameters for disease diagnosing and/or monitoring, etc.) and/or the acknowledgement of the counseling or warning and agreement to the complement inhibitor treatment from the patient, are collected and stored, preferably in a database via a computer readable medium. In still another preferred embodiment, such collected information is reported fully or partially to any drug manufacturer, supplier, distributor, prescriber, supervising professional personnel, patients who are taking or have a potential to take such drug, and/or any regulatory agencies (e.g., the U.S. FDA or the corresponding governmental offices in the country where the complement inhibitor is distributed). In another preferred embodiment, such collected information is updated and/or modified (e.g. with updated patient information and/or any change in the acknowledgement and agreement from the patient, or with updated counseling information or warning based on postmarketing studies or research), preferably in a periodic manner, and reported as described herein.

The present disclosure also features a database prepared by the methods disclosed herein, preferably via a computer readable medium, containing registered patients' information. Such patient information may include patient personal information (e.g., bibliographic information, personal or family disease and/or treatment record, and the fact or potential to have at least one of the adverse clinical events after discontinuing use of the complement-inhibiting drug) and the patient's acknowledgement the potential adverse reactions after drug discontinuation and agreement to drug treatment as described herein. Such patient information may be updated, preferably periodically, and be provided to any relevant personnel, facility, organization, or authority as described herein.

The present disclosure also features a method to distribute the complement inhibitor disclosed herein to a physician or a pharmacy who will further distribute the inhibitor to a patient who has a complement-associated disorder disclosed herein for a treatment of said disorder. In some embodiments, the inhibitor will be authorized for distribution to the physician or pharmacy only upon certification from the physician or pharmacy that:

i) the physician or pharmacy has received one or both of verbal and written warning as to the risk of adverse clinical events associated with discontinuing use of the complement inhibitor to treat the disorder; and

ii) the physician or pharmacy will distribute the warning to the patient, or the legal guardian or representative of the patient.

Preferably, the certification and the information of the physician or pharmacy will be registered via a computer readable medium into a database. The physician or pharmacy may require a certification or acknowledgement of receiving and understanding of the warning disclosed herein and/or an agreement of the treatment from the patient, or the legal guardian or representative of the patient prior to or at the same time of distributing the complement-inhibiting drug disclosed herein to the patient, or the legal guardian or representative of the patient. Such certification or acknowledgement and/or agreement may be further submitted to the drug distributor, manufacturer, and/or regulatory authorities, who may register such information into a database via a computer readable medium. Preferably, such information, including the certification or acknowledgement and/or agreement from the physician (or pharmacy) or the patient (or the legal guardian or representative of the patient) or both, is to be received prior to or at the same time of or in a reasonable time frame after distributing the complement-inhibiting drug to the physician or pharmacy. In one embodiment, the certification is to be received after the distribution of the inhibitor to the physician or pharmacy but prior to the distribution of the inhibitor to the patient, or the legal guardian or representative of the patient.

The present disclosure also features a method of creating a database of physicians or pharmacies who will be allowed to distribute the complement inhibitor disclosed in this application for use in treating a complement-associated disorder. In some embodiments, the database is registered via a computer readable medium containing information that the physicians or pharmacies have received and acknowledged one or both of verbal and written warning as to the risk of adverse clinical events associated with discontinuing use of a complement inhibitor to treat the disorder and agreed to distributing the warning to the patient who has the disorder, or the legal guardian or representative of the patient.

In a non-limiting example, the complement-associated disorder disclosed herein is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD).

The present disclosure also features a database of physicians or pharmacies created by the methods disclosed herein.

The present disclosure also features a method to manufacture the complement inhibitor described herein. The potential manufacturer should obtain an approval from a relevant government regulatory authority for manufacturing for sale the specific drug for the specific disease or indication. The regulatory authority (including, for example, the U.S. FDA and other corresponding agencies in the country or region where the drug will be manufactured and/or sold) will make a decision whether to approve this request based on the previously submitted drug information including, for example, the adverse clinical events after drug discontinuation and the patient information comprising the real events after drug discontinuation. Upon approval, the potential manufacturers may manufacture the complement-inhibiting drug in the approved country or region. Additionally, the manufacturer may be further required to produce or ensure the production of a document which provides a warning or caution comprising the whole or part of the information submitted to the regulatory authority, for example, the adverse clinical events after drug discontinuation. The manufacturer may be further required to provide the manufactured drug together with the produced document to any relevant personnel, facility, organization, or authority, if necessary.

The present disclosure also features a method to distribute the complement inhibitor described herein. The potential distributor should obtain an approval from a relevant government regulatory authority for distributing the specific drug for the specific disease or indication. The regulatory authority (including, for example, the U.S. FDA or other corresponding agencies in the country or region where the drug will be distributed) will make a decision whether to approve this request based on the previously submitted drug information including, for example, the adverse clinical events after drug discontinuation and the patient information comprising the real events after drug discontinuation. Upon approval, the potential distributor may distribute the complement-inhibiting drug in the approved country or region. Additionally, the distributor may be further required to produce or ensure the production of a document which provides a warning or caution comprising the whole or part of the information submitted to the regulatory authority, for example, the adverse clinical events after drug discontinuation. Alternatively, the distributor may receive the document from the relevant manufacturer or the authority. The distributor may be further required to provide the manufactured drug together with the produced document to any relevant personnel, facility, organization, or authority, if necessary.

As used herein, a “memory” refers to the physical devices used to store programs or data on a temporary or permanent basis for use in a computer or other digital electronic device. A “computer readable medium” refers to a medium capable of storing data in a format readable by a computer or a computer-related mechanical device. Examples of such computer readable media include magnetic media such as magnetic disks, cards, tapes, and drums, punched cards and paper tapes, optical disks (e.g., CD, CD-ROM, CD-R, CD-RW, DVD, etc.), and other media well known in the art.

The present disclosure also features a system for distributing the disclosed complement inhibitor (CI1) for use in treating a patient: (i) afflicted with, suspected of having, or at risk for developing a complement-associated disorder, and (ii) in need of treatment with the complement inhibitor. As a non-limiting example, the system comprises: a memory or a storage device for storing information about the patient and about whether an instruction to distribute the complement inhibitor is executed; and a processor configured to execute the instruction. In some embodiments, the instruction causes the processor to perform the steps comprising:

i) searching the memory or storage device for certifications that:
(a) the patient, or the legal guardian or representative of the patient, is competent to comprehend and assess information and to make decisions;
(b) the patient, or the legal guardian or representative of the patient, has received one or both of verbal and written warning as to the risk of adverse clinical events associated with discontinuing use of the complement inhibitor to treat the disorder; and
(c) the patient, or the legal guardian or representative of the patient, has expressed acknowledgment of the warning and agreement to the treatment;

ii) upon the identification of certifications in step i), authorizing distribution of the complement inhibitor to treat the patient; and

iii) registering via the memory or storage device the distribution of the complement inhibitor.

The systems and methods disclosed herein can be implemented on a computer system, server, or other electronic device, that is capable of storing information or processing information. In some embodiments the system includes one or more computer systems, servers, or other electronic devices capable of storing information or processing information.

The systems store information on paper or on a computer readable medium. The stored information may include, for example, the basic information and clinical record of the patient, the information about the manufacturer(s) who will manufacture the complement inhibitor, the information about the pharmacy(s) or the physician(s) who will distribute the complement inhibitor to the patient, the information about the distribution of the warning regarding the disclosed adverse clinical events to the patient, the legal guardian or representative of the patient, and/or the pharmacy(s) or the physician(s), and the acknowledgement of receiving of such information and/or agreeing to the treatment by the patient, its legal guardian or representative, and/or the pharmacy(s) or the physician(s). The system disclosed herein may further store information including, for example, the information about the discontinuing use of the complement inhibitor by the patient, the information that the patient is monitored for adverse clinical events prior to, at the same time of, or after the discontinuation, and the information that the patient is treated by re-initiation of the complement inhibitor (CI1) treatment or with an alternative therapy to treat the adverse clinical events after the discontinuing use of the complement inhibitor (CI1).

The information stored in the system disclosed herein can be collected in a voluntary or mandatory manner from the corresponding patient (or his or her legal guardian or representative), the manufacturer or distributor of the complement inhibitor, and/or the pharmacy or the physician who will distribute the complement inhibitor to the patient. The information can be stored and created, for example, into a database. The information can be reported to a government regulatory agency in a voluntary or mandatory manner. In some embodiments, a review of such reported information followed by an approval from the government regulatory agency is required prior to the distribution of the complement inhibitor. The collection and/or the submission of the information disclosed herein can be executed by hand, mail, telephone, facsimile transmission, or on-line transmission.

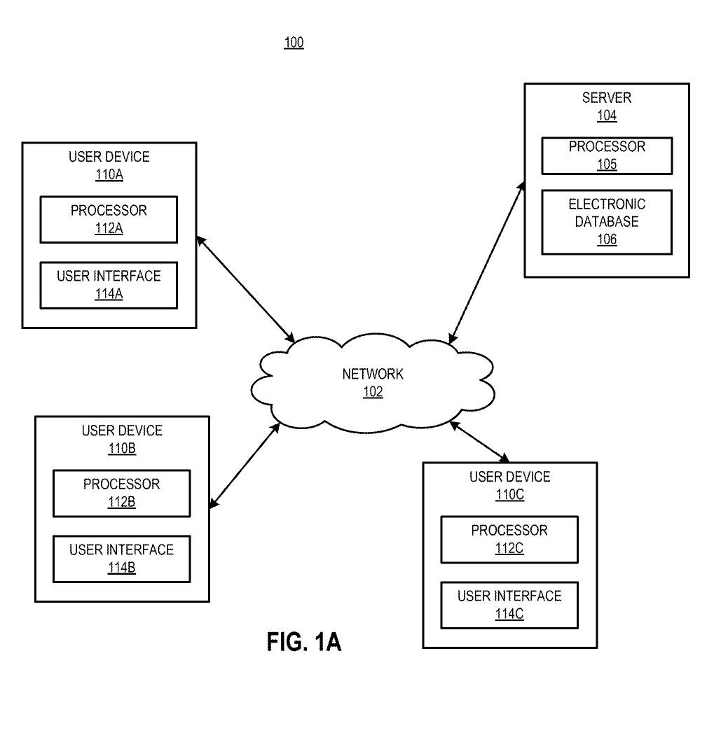

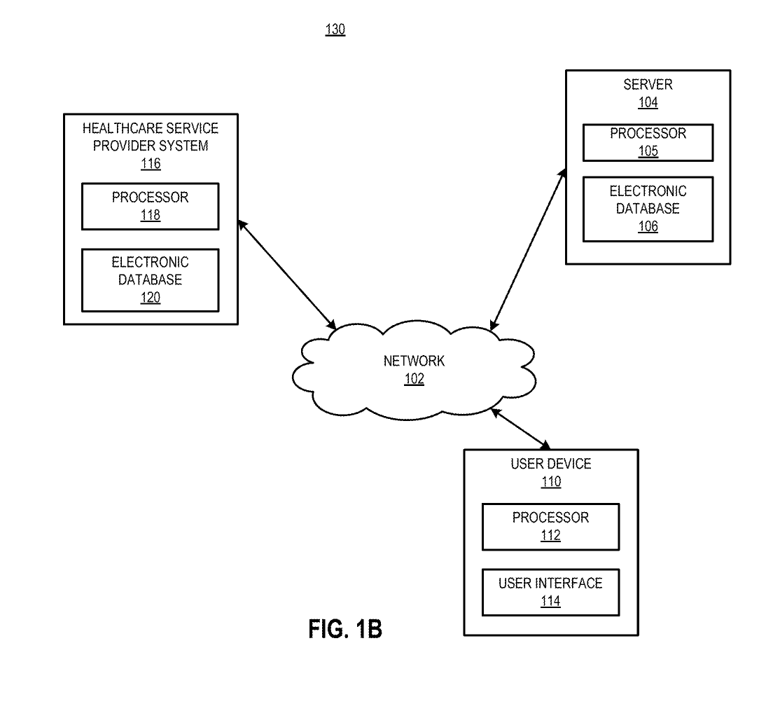

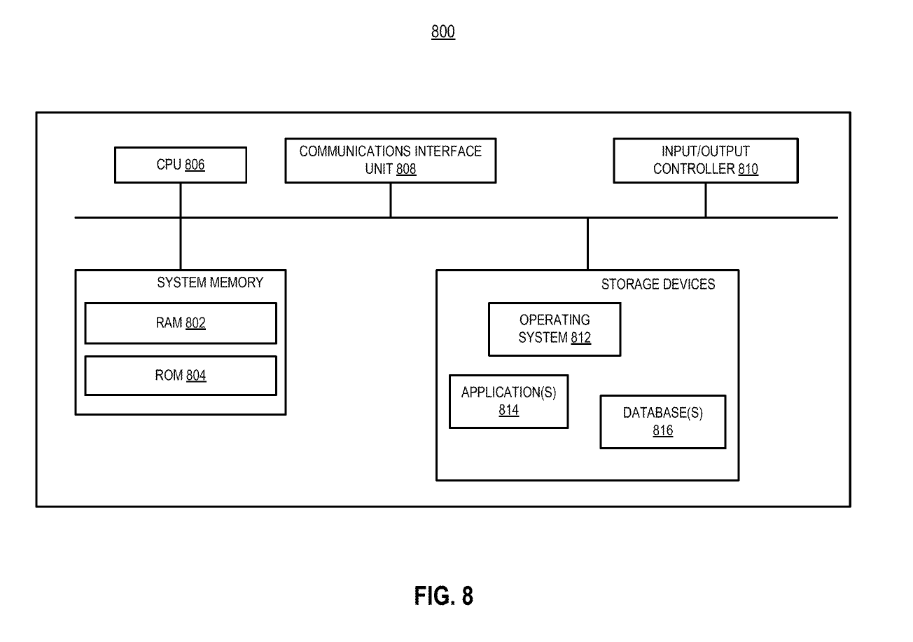

FIGS. 1A and 1B depict example network and database structures that may be used to implement the systems and methods disclosed herein. In particular, FIG. 1A is a block diagram of a computerized system 100 for authorizing the distribution of a drug to patients, according to an illustrative implementation. The system 100 includes a server 104 and three user devices 110A-110C (generally, user device 110) connected over a network 102 to the server 104. The server 104 includes a processor 105 and an electronic database 106, and each user device 110 includes a processor 112 and a user interface 114. As used herein, the term “processor” or “computing device” refers to one or more computers, microprocessors, logic devices, servers, or other devices configured with hardware, firmware, and software to carry out one or more of the computerized techniques described herein. Processors and processing devices may also include one or more memory devices for storing inputs, outputs, and data that is currently being processed. An illustrative computing device 800, which may be used to implement any of the processors and servers described herein, is described in detail below with reference to FIG. 8. As used herein, “user interface” includes, without limitation, any suitable combination of one or more input devices (e.g., keypads, touch screens, trackballs, voice recognition systems, etc.) and/or one or more output devices (e.g., visual displays, speakers, tactile displays, printing devices, etc.). As used herein, “user device” includes, without limitation, any suitable combination of one or more devices configured with hardware, firmware, and software to carry out one or more of the computerized techniques described herein. Examples of user devices include, without limitation, personal computers, laptops, and mobile devices (such as smartphones, blackberries, PDAs, tablet computers, etc.). One server and three user devices are shown in FIG. 1A. However, the arrangement and number of components shown in FIG. 1A are merely illustrative, and the system 100 can support multiple servers and any number of user devices in any suitable configuration.

The components of the system 100 of FIG. 1A may be arranged, distributed, and combined in any of a number of ways. For example, the components of system 100 may be distributed over multiple processing and storage devices connected via the network 102. Such an implementation may be appropriate for distributed computing over multiple communication systems including wireless and wired communication systems that share access to a common network resource. In some implementations, system 100 is implemented in a cloud computing environment in which one or more of the components are provided by different processing and storage services connected via the Internet or other communications system. For example, the server 104 may be implemented as virtual servers instantiated in a cloud computing environment. The electronic database 106 may be a distributed system of databases that includes data regarding patient information such as a patient's demographic features (such as date of birth, gender, height, weight, or any other demographic feature), diagnosis, prognosis, administered medications, symptoms, physicians, pharmacists, geographical location, or any other suitable data related to a patient. The improved availability associated with using distributed architecture advantageously facilitates continuous tracking and logging of inputs from various patients, physicians, pharmacists, or any other suitable representative of a patient.

The components of FIG. 1A may be implemented as one or more components included with or local to a user device 110. For example, FIG. 1A depicts a user device 110 that includes a processor 112 and a user interface 114. The processor 112 may be configured to perform any of the functions described herein for the user interface 114. Additionally, the functions performed by each of the components in system 100 may be rearranged. In some implementations, the processor 112 may perform some or all of the functions of the processor 105 as described herein. Any suitable variation of this system may be used.

A user provides user input over the user interface 114. The user may be the patient or a representative of the patient such as a legal guardian, physician, pharmacist, or nurse. The user input may include any data related to a patient. In particular, the user input includes data indicative of the patient's identity, such as the patient's name or an identification number associated with the patient such as a social security number, a healthcare insurance number. The processor 112 transmits this data over the network 102 to the server 104, and the processor 105 parses the electronic database 106 for a previous registration of the patient.

If the patient has been previously registered, the user provides data indicative of an event in the patient's care. For example, an event may include an administration of a drug, a symptom expressed by the patient, a measurement of a level of physiological parameter related to the patient, or any other suitable event (e.g., an adverse clinical event) related to the care of the patient. The event data is then transmitted over the network 102, received by the processor 105, and stored in the electronic database 106.

Alternatively, if the patient has not been previously registered, the user device 110 is configured to prompt the user to register the patient. Registration of a patient may require several electronic certifications over the user interface 114, including a certification that a representative of the patient is competent and can make decisions regarding the patient's treatment. In addition, the representative receives a warning regarding the risk of adverse clinical events associated with the use of a drug to treat the patient. Another possible required certification for registration of the patient is that the representative has acknowledged receipt of the warning. A third possible certification requires that the representative agrees to using the drug in treatment for the patient.

When registration is complete at the user interface 114, the processor 112 transmits the new patient's data over the network 102 to the server 104, where the data is stored in the electronic database 106 as a registered patient. Then, the processor 105 updates an electronic authorization variable associated with the registered patient, thereby authorizing distribution of the drug for use in treating the patient. The same user device 110 may be used to register different patients. Similarly, data regarding a given patient may be provided over multiple user devices 110 over the course of the patient's treatment. In this way, system 100 provides a secure method of authorizing distribution of a drug to patients with representatives who acknowledge a risk of adverse clinical events associated with the drug.

The components of FIG. 1B are similar to those of FIG. 1A, with the exception that FIG. 1B additionally includes a healthcare service provider system 116 including a processor 118 and an electronic database 120. In some implementations, the healthcare service provider system 116 is configured to share patient-related data stored on the electronic database 120 with the server 104. In particular, the healthcare service provider system 116 may have additional data regarding a registered patient that have not been directly provided by a user device 110. For example, the user device 110 may have been used to register a patient for a particular disorder. At a later time, the same patient may be treated at a hospital for a different disorder, and the hospital may monitor patient treatments and symptoms. The hospital staff may have provided data indicative of the patient's treatment and/or symptoms to the healthcare service provider system 116, which stores the data on the electronic database 120. The data on the electronic database 120 is then shared with the server 104. By aggregating patient-related data across different sources, the server 104 is more likely to maintain an updated patient history and achieves a more accurate patient profile.

The patient data stored on the electronic databases 106 and 120 may include private and classified information, and it is desirable to maintain a degree of confidentiality. The systems 100 and 130, and every system disclosed herein, are configured to comply with any privacy or confidentiality laws that may exist in the jurisdiction in which the system is installed. In some implementations, all data in relation to all patients is processed using encryption and decryption algorithms to ensure secure data transmission over the network 102.

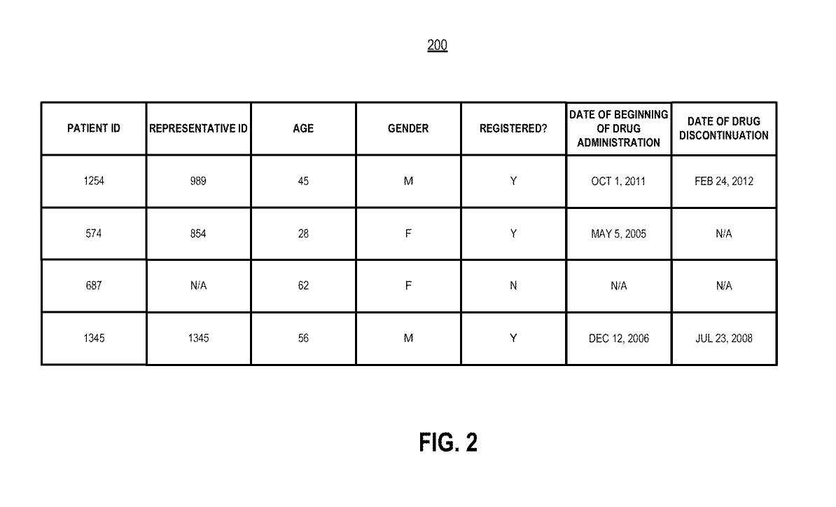

FIG. 2 depicts a data structure 200 for records in a patient database, which may be stored on the electronic database 106. The data structure 200 includes a list of patient identification numbers, representative identification numbers, and patient-related data. Upon registration, each patient may be labeled with a patient identification number, and in addition, the representative of each patient may also be labeled with a representative identification number. For example, the representatives of the patients 1254 and 574 may be legal guardians, physicians, pharmacists, or any other suitable representative. In addition, a patient may be his/her own representative, as is the case with patient 1345.

The data structure 200 further includes the ages and genders of the patients, and a flag variable representative of whether the patient is registered. For registered patients, a date indicating the beginning of the administration of the drug and a date indicating the discontinuation of the drug administration are also recorded, if applicable. For example, the patients 1254 and 1345 were administered the drug for an amount of time before discontinuation, and the treatment of patient 576 still includes the use of the drug. The patient 687 has not yet been registered, and so there is no corresponding representative identification number or dates of beginning and discontinuation of drug administration.

The data structure 200 may also include further patient-related information, such as dates of actual administration of the drug, doses of the administered drug, patient symptoms, or any other suitable patient-related information. In particular, the data structure 200 may be updated periodically with data generated from patient reports that may be prepared by the patient or a representative of the patient. In this way, the data structure 200 may track the progression of a patient throughout the patient's treatment. By storing patient-related data in this way, the system 100 provides a method for monitoring a patient's progress during treatment and also provides a rich database with information that may provide insight for future decisions regarding the same patient or a patient with similar characteristics.

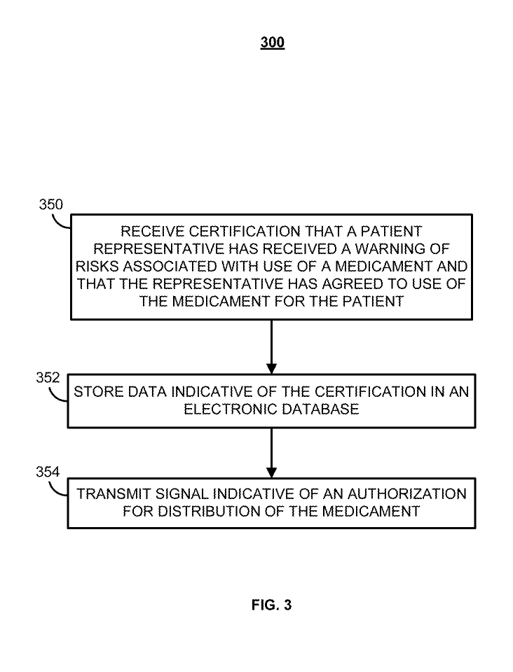

FIG. 3 is a flowchart of a method 300 that may be implemented by the server 104 to authorize distribution of a drug for use in treating a patient. The method 300 includes the steps of receiving certification that a patient representative has received a warning of risks associated with use of a complement inhibitor (or a drug) and that the representative has agreed to use of the complement inhibitor for the patient (step 350), storing data indicative of the certification in an electronic database (step 352), and transmitting a signal indicative of an authorization for distribution of the complement inhibitor (step 354).

At step 350, the server 104 receives certification from a user device 110 that a representative of a patient has received a warning regarding the risks associated with the use of a complement inhibitor. Furthermore, the server 104 also receives certification that the representative has agreed to the use of the complement inhibitor in treatment for the patient. In particular, the representative may be required to provide an acknowledgment of receipt of the warning as well as agreement to use of the complement inhibitor in the form of a signature or any other suitable form of certification. This certification may then be electronically acknowledged at a user interface 114, and a signal representative of the certification may be transmitted over the network 102 and received by the server 104.

After receiving the certification, at step 352, the server 104 stores data indicative of the certification in an electronic database 106. For example, a data structure such as data structure 200 or any other suitable data structure may be stored in the electronic database 106 to track the registration status of patients.

At step 354, the server 104 authorizes the distribution of the complement inhibitor by transmitting a signal over the network 104 to the user device 110. The signal is indicative of the authorization to use the complement inhibitor in treating the registered patient.

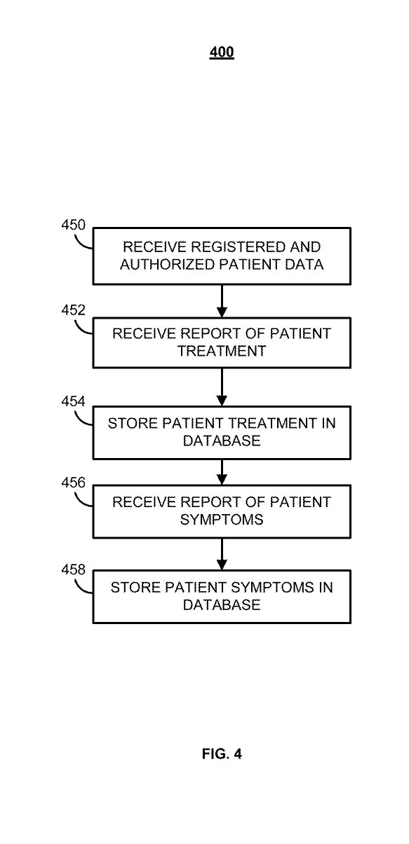

FIG. 4 is a flowchart of a method 400 that may be implemented by the server 104 to receive and store patient-related data. The method 400 includes the steps of receiving registered and authorized patient data (step 450), receiving a report of patient treatment (step 452), storing the patient treatment in a database (step 454), receiving a report of patient symptoms (step 456), and storing the patient symptoms in the database (step 458).

At step 450, the server 104 receives data related to a registered patient from a user device 110. For example, a user at the user device 110 may wish to enter patient-related data into the electronic database 106 and first provides some data identifying the patient. The received data may include the patient's identification number such as depicted in the first column of data structure 200, or any other suitable data identifying a patient.

At step 452, the server 104 receives an electronic report of features of a patient's treatment. The report may include information such as a drug that was administered to the patient, the time and date of administration, and an amount of the administered drug. The report may further include an identity of a person who administered the drug, where the administration took place, or any other information related to a treatment of the patient.

At step 454, the server 104 stores data corresponding to the received report of patient treatment in the electronic database 106. In some implementations, the processor 105 is configured to process the received report before storage. For example, the information in the received report may be sorted or categorized to facilitate efficient future retrieval of the data.

At step 456, the server 104 receives a report of patient symptoms that are determined during one or more subsequent treatment sessions or evaluations of the patient at the same or different health care facility. The report may include quantitative measures such as the patient's temperature, blood pressure, or any other suitable physiological metric used to monitor a patient's overall health. In addition, the report may also include information such as such as aches, inflammation, irritation, discoloration, or any other suitable symptom identified during that subsequent session. The symptom report may also include times or time intervals corresponding to each symptom.

At step 458, the patient symptoms are stored in the electronic database 106. In some implementations, the processor 105 is configured to process the received patient symptoms before storage. As an example, the information in the received patient symptom report may be processed to facilitate efficient future retrieval of the data and to efficiently group a large number of patients together who exhibit similar symptoms. In particular, a quantitative measure such as the patient's temperature may be categorized as very high, high, normal, low, or very low, for example.

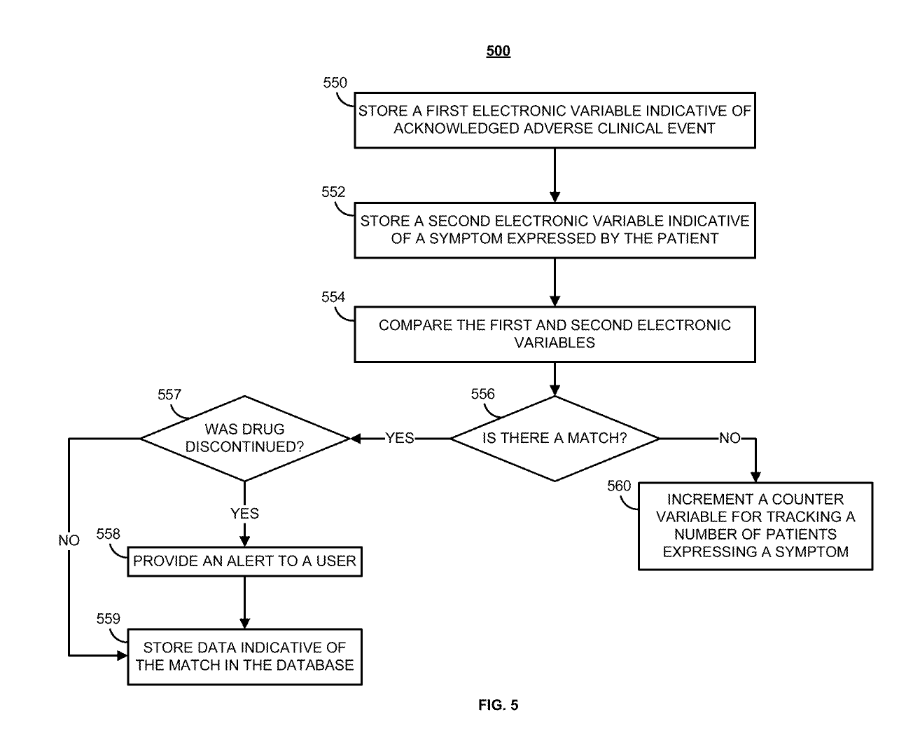

FIG. 5 is a flowchart of a method 500 that may be implemented by the server 104 to compare a symptom expressed by a patient with an adverse clinical event, such as an adverse event corresponding to a risk certified previously by the patient or the patient's representative (e.g., FIG. 3). The method 500 includes the steps of storing a first electronic variable indicative of an acknowledged adverse clinical event (step 550) and storing a second electronic variable indicative of a symptom expressed by the patient (step 552). The first and second electronic variables are compared (step 554), and the processor 105 determines whether there is a match between the two variables (step 556). If a match is identified, then data indicative of the match is stored in the electronic database 106 (step 558), and a warning or other indicator may be provided. A counter variable may be incremented that tracks a number of patients expressing a symptom that is not included as an adverse clinical event (step 560).

At step 550, the server 104 stores a first electronic variable indicative of an adverse clinical event acknowledged by the patient's representative during patient registration. The first electronic variable may be an identification number corresponding to the clinical event, or may simply be a flag variable indicating that the adverse clinical event has been acknowledged by the patient's representative.

At step 552, the server 104 stores a second electronic variable indicative of a symptom expressed by the patient. The second electronic variable may be an identification number corresponding to the symptom and may have been received with the report of patient symptoms as described in relation to FIG. 4. In an example, the report of patient symptoms may have been processed to determine a value for the second electronic variable.

At step 554, the first and second electronic variables are compared. The processor 105 may perform some processing on one or both of the electronic variables in order to get the variables into a form suitable for comparison.

At step 556, the server 104 determines whether there is a match between the two electronic variables. In particular, a match requires that the expressed symptom corresponds to the adverse clinical event in some way. Furthermore, a match may be associated with a match strength value. For example, an adverse clinical event associated with a drug may be that the patient is susceptible to a rise in temperature by at least 5 degrees. If the patient exhibits an increase in temperature of 6 degrees after being administered the drug, the server 104 may associate one match strength value with the patient. If another patient exhibits an increase in temperature of 10 degrees after being administered the drug, the server 104 may associated a stronger match strength value with the other patient. These match strength values may be also be stored in the electronic database 106 when updating the patient's information.

When the server 104 determines a match has occurred, at step 557, the server 104 determines whether the drug was discontinued prior to the expression of the symptom by the patient. In particular, if the drug was discontinued prior to the expression of the symptom, at step 558, the server 104 provides an alert to a user. The alert may include information indicating that a match between a risk of a side effect that was acknowledged by the patient's representative and associated with discontinuing use of the drug and a symptom expressed by the patient has occurred. At step 559, the server 104 may store data indicative of the match, such as the match strength value, or a flag variable indicating the match, is stored in the electronic database 106 at step 558.

If the server 104 determines there is no match between the first and second electronic variables, at step 560, the server 104 may increment a counter variable. The counter variable corresponds to the expressed symptom and represents a number of registered patients that have expressed the symptom during a predefined time interval after administration of the drug. The time interval may be a minute, an hour, a day, a week, or any other suitable time interval corresponding to an expression of a symptom after drug administration. The server 104 may store counter variables for a number of various symptoms not normally associated with the drug. The server 104 may also store separate counter variables for categories of patients, sorted by their age, gender, or any other suitable category for a patient. By incrementing these counter variables, the server 104 keeps track of a number of patients expressing particular symptoms and can transmit an alert to an authorized user when the number of patients exceeds some threshold. In this way, the server 104 may detect symptoms that are often expressed by patients in a particular category, in which the symptoms were not previously associated with the drug.

Then, steps 552-560 may be repeated for each symptom retrieved from a received symptom report for comparison to an adverse clinical event. Furthermore, method 500 may be repeated for each adverse clinical event listed in the warning received by the patient's representative for comparison to each recorded symptom expressed by the patient.

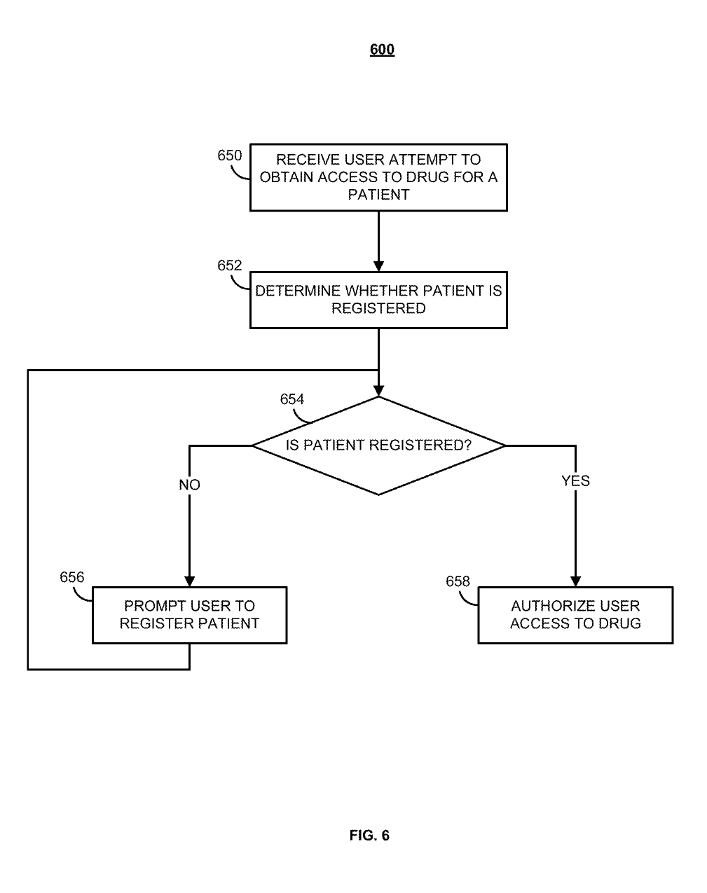

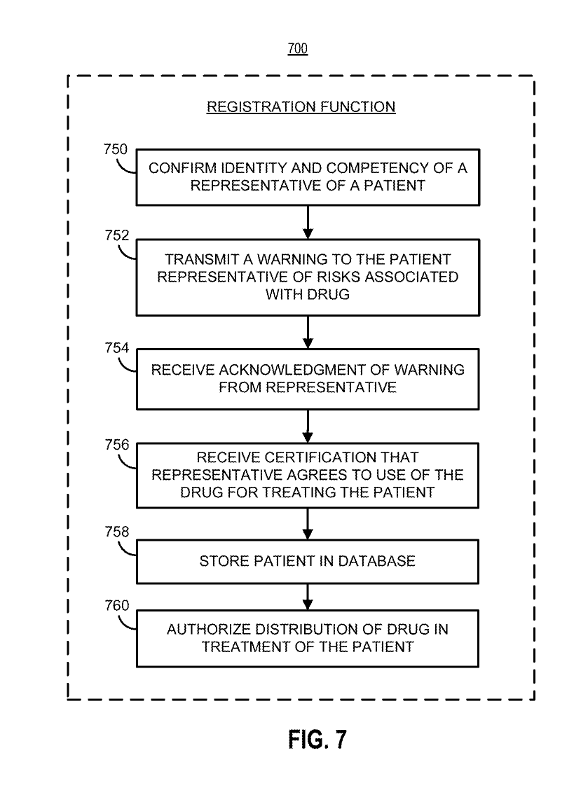

FIG. 6 is a flowchart of a method 600 that may be implemented by the server 104 to determine whether to authorize a user access to a drug. The method 600 includes the steps of receiving a user attempt to obtain access to a drug for a patient (step 650) and determining whether the patient is registered (step 652). If the patient is registered, the server 104 authorizes the user to obtain access to the drug (step 658). Otherwise, the user is prompted to register the patient in the database (step 656). The patient may be registered by the method described in FIG. 7.

FIG. 7 is a flowchart of a method 700 that may be implemented by the server 104 to register a patient. The method 700 includes the steps of confirming an identity and a competency of a representative of the patient (step 750), transmitting a warning to the patient representative of risks associated with the drug (step 752), receiving acknowledgment of the warning from the representative (step 754), receiving certification that the representative agrees to the use of the drug in treating the patient (step 756), storing the patient in the database (step 758), and authorizing the distribution of the drug for treating the patient (step 760).

FIG. 8 is a block diagram of a computing device, such as any of the components of the systems of FIGS. 1A-1B, for performing any of the processes described herein. Each of the components of these systems may be implemented on one or more computing devices 800. In certain aspects, a plurality of the components of these systems may be included within one computing device 800. In certain implementations, a component and a storage device may be implemented across several computing devices 800.

The computing device 800 comprises at least one communications interface unit, an input/output controller 810, system memory, and one or more data storage devices. The system memory includes at least one random access memory (RAM 802) and at least one read-only memory (ROM 804). All of these elements are in communication with a central processing unit (CPU 806) to facilitate the operation of the computing device 800. The computing device 800 may be configured in many different ways. For example, the computing device 800 may be a conventional standalone computer or alternatively, the functions of computing device 800 may be distributed across multiple computer systems and architectures. In FIG. 8, the computing device 800 is linked, via network or local network, to other servers or systems.

The computing device 800 may be configured in a distributed architecture, wherein databases and processors are housed in separate units or locations. Some units perform primary processing functions and contain at a minimum a general controller or a processor and a system memory. In distributed architecture implementations, each of these units may be attached via the communications interface unit 808 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 806 comprises a processor, such as one or more conventional microprocessors and one or more supplementary co-processors such as math co-processors for offloading workload from the CPU 806. The CPU 806 is in communication with the communications interface unit 808 and the input/output controller 810, through which the CPU 806 communicates with other devices such as other servers, user terminals, or devices. The communications interface unit 808 and the input/output controller 810 may include multiple communication channels for simultaneous communication with, for example, other processors, servers or client terminals.

The CPU 806 is also in communication with the data storage device. The data storage device may comprise an appropriate combination of magnetic, optical or semiconductor memory, and may include, for example, RAM 802, ROM 804, flash drive, an optical disc such as a compact disc or a hard disk or drive. The CPU 806 and the data storage device each may be, for example, located entirely within a single computer or other computing device; or connected to each other by a communication medium, such as a USB port, serial port cable, a coaxial cable, an Ethernet cable, a telephone line, a radio frequency transceiver or other similar wireless or wired medium or combination of the foregoing. For example, the CPU 806 may be connected to the data storage device via the communications interface unit 808. The CPU 806 may be configured to perform one or more particular processing functions.

The data storage device may store, for example, (i) an operating system 812 for the computing device 800; (ii) one or more applications 814 (e.g., computer program code or a computer program product) adapted to direct the CPU 806 in accordance with the systems and methods described here, and particularly in accordance with the processes described in detail with regard to the CPU 806; or (iii) database(s) 816 adapted to store information that may be utilized to store information required by the program.

The operating system 812 and applications 814 may be stored, for example, in a compressed, an uncompiled and an encrypted format, and may include computer program code. The instructions of the program may be read into a main memory of the processor from a computer-readable medium other than the data storage device, such as from the ROM 804 or from the RAM 802. While execution of sequences of instructions in the program causes the CPU 806 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to aligning dietary behavior as described herein. The program also may include program elements such as an operating system 812, a database management system and “device drivers” that allow the processor to interface with computer peripheral devices (e.g., a video display, a keyboard, a computer mouse, etc.) via the input/output controller 810.

The term “computer-readable medium” as used herein refers to any non-transitory medium that provides or participates in providing instructions to the processor of the computing device 800 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 806 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 800 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

All references cited herein, including patent applications and publications, are hereby incorporated by reference in their entirety. Various modifications of the disclosure, in addition to those described herein, will be apparent to those skilled in the art from the foregoing description. Such modifications are also intended to fall within the scope of the appended claims.

1-85. (canceled)

86. A method of creating a database of patients who have a complement-associated disorder, comprising registering via a computer readable medium a database containing information of the patients, wherein the information includes that the patients, or the patients' legal guardians or representatives, have received one or both of verbal and written warning as to the risk of adverse clinical events associated with discontinuing use of an inhibitor of complement protein C5 to treat the disorder.

87. The method of claim 86, wherein the information further comprises that the patients, or the patients' legal guardians or representatives, have acknowledged the warning and agreed to the inhibitor treatment.

88. The method of claim 86, wherein the disorder is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD).

89. The method of claim 86, wherein the inhibitor of complement protein C5 is an antibody or antigen-binding fragment thereof recognizing C5.

90. The method of claim 89, wherein the antibody or antigen-binding fragment is eculizumab (Soliris®), pexelizumab, or a biosimilar equivalent of eculizumab or pexelizumab.

91. The method of claim 86, wherein the adverse clinical events comprise thrombotic microangiopathy (TMA) or a TMA-related complication.

92. A database of patients who have a complement-associated disorder created by the method of claim 86.

93. A method for reporting at least one adverse event to a government regulatory agency comprising searching the database of claim 92 to determine information about patients having a complement-associated disorder and experiencing at least one adverse clinical event upon discontinuation of a therapy with an inhibitor of complement protein C5 and communicating the information to a government regulatory agency.

94. A method of creating a database of physicians or pharmacies who will distribute an inhibitor of complement protein C5 for use in treating patients having a complement-associated disorder comprising registering via a computer readable medium a database containing information that the physicians or pharmacies have received and acknowledged one or both of verbal and written warning as to the risk of adverse clinical events associated with discontinuing use of the inhibitor to treat the disorder and agreed to distributing the warning to the patients who have the disorder, or the legal guardians or representatives of the patients.

95. The method of claim 94, wherein the disorder is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD).

96. The method of claim 94, wherein the inhibitor of complement protein C5 is an antibody or antigen-binding fragment thereof recognizing C5.

97. The method of claim 96, wherein the antibody or antigen-binding fragment is eculizumab (Soliris®), pexelizumab, or a biosimilar equivalent of eculizumab or pexelizumab.

98. The method of claim 94, wherein the adverse clinical events comprise thrombotic microangiopathy (TMA) or a TMA-related complication.

99. A database of physicians or pharmacies created by the method of claim 94.

100. A method for authorizing a distribution of an inhibitor of complement C5 for use in treating a patient afflicted with, suspected of having, or at risk of developing a disorder, and in need of treatment with the inhibitor comprising:
receiving, by a processor, certification that a representative of the patient has acknowledged receipt of a warning of a risk of an adverse clinical event associated with discontinuing use of the inhibitor and that the representative of the patient has agreed to use of the inhibitor in treating the patient;
storing data indicative of the certification in an electronic database; and
transmitting a signal indicative of an authorization for distribution of the inhibitor for use in treating the patient.

101. The method of claim 100, further comprising storing, in the electronic database, a first electronic variable indicative of the adverse clinical event.

102. The method of claim 101, further comprising receiving and storing in the electronic database a second electronic variable indicative of a symptom expressed by the patient.

103. The method of claim 102, further comprising:
comparing, by the processor, the first and second electronic variables;
identifying a match between the identified adverse clinical event and the expressed symptom;
assessing whether use of the inhibitor was discontinued prior to an expression of the symptom by the patient; and
storing data indicative of the identified match in the electronic database.

104. The method of claim 100, further comprising receiving and storing in the electronic database indicative of a time and an amount that the inhibitor was administered to the patient.

105. The method of claim 100, wherein the disorder is selected from the group consisting of: a complement-associated inflammatory disorder, paroxysmal nocturnal hemoglobinuria (PNH), atypical hemolytic uremic syndrome (aHUS), age-related macular degeneration (AMD), rheumatoid arthritis (RA), myasthenia gravis (MG), neuromyelitis optica (NMO), catastrophic anti-phospholipid syndrome (CAPS), anti-phospholipid syndrome (APS), sepsis, a complement-associated pulmonary disorder, asthma, and chronic obstructive pulmonary disease (COPD).
